(19) United States
(12) Patent Application Publication
(10) Pub. No.: US 2014/0147819 A1
(43) Pub. Date: May 29, 2014

(54) INTERACTIVE LIFESTYLE REINFORCEMENT GAMES AND COMPUTER-IMPLEMENTED SYSTEMS AND METHODS FOR CONDUCTING THEREOF

(71) Applicants: Adam Cricchio, Dobbs Ferry, NY (US); Helen Lee, Brooklyn, NY (US); Alexandria Stried, New York, NY (US); Melanie Mannarino, Springfield, NJ (US)

(72) Inventors: Adam Cricchio, Dobbs Ferry, NY (US); Helen Lee, Brooklyn, NY (US); Alexandria Stried, New York, NY (US); Melanie Mannarino, Springfield, NJ (US)

(21) Appl. No.: 14/091,084

(22) Filed: Nov. 26, 2013

Related U.S. Application Data
(60) Provisional application No. 61/730,029, filed on Nov. 26, 2012.

(51) Int. Cl. A63F 13/00

(52) U.S. Cl. CPC A63F 13/005
USPC 434/238

(57) ABSTRACT

In some embodiments, the instant invention provides for a computer-implemented interactive lifestyle reinforcement game that includes steps of: displaying a first visual area and a second visual area of the game; where the first visual area includes X panes with descriptions of routines and activities; where the second visual area includes Y subareas, and where a number of Y subareas is less than a number of X panes; moving each X pane selected by a player into one of the Y subareas of the second visual area until all Y subareas are filled; displaying indication that identifies player's progress in performing selected routine and/or activity; automatically removing a completed routine or a completed activity from an associated Y subarea; allowing the player to select a new routine, a new activity, or both; and repeating steps based on the player's desire or until there are no more available X panes.

### RELATED APPLICATIONS

This application claims the priority of U.S. provisional application Ser. No. 61/730,029, entitled “METHODS AND SYSTEMS FOR CONDUCTING INTERACTIVE LIFESTYLE REINFORCEMENT GAMES RELATED TO ACTIVITIES OR ROUTINES,” filed Nov. 26, 2012, which is incorporated herein by reference in its entirety for all purposes.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

In some embodiments, the instant invention is related to interactive lifestyle reinforcement games and computer-implemented systems and methods for conducting thereof.

### BACKGROUND OF INVENTION

Typically, a performance of repetitive tasks can result in establishment of a particular behavior pattern. Typically, the performance of repetitive tasks can be more enjoyable if those tasks are part of or associated with a game.

### BRIEF SUMMARY OF INVENTION

In some embodiments, the instant invention provides for a computer-implemented interactive lifestyle reinforcement game that includes at least the following steps of: (1) displaying, by a specifically programmed computer system, to a player, a first visual area and a second visual area of the game; where the first visual area includes a first plurality of X panes, where each X pane includes: i) at least one first description of at least one first routine that the player can select to perform, or ii) at least one second description of at least one first activity that the player can select to perform; where the second visual area includes Y subareas, and where a first number of Y subareas is less than a second number of the first plurality of X panes; (2) moving, by the specifically programmed computer system, each X pane selected by the player into one of the Y subareas of the second visual area until all Y subareas are filled with the player's selected X panes; (3) periodically and automatically requesting, by the specifically programmed computer system, from the player, to confirm that the player has performed each selected routine, each selected activity, or both; where a frequency of requesting depends, at least in part, on: i) at least one first performance condition associated with such selected routine, ii) at least one second performance condition associated with such selected activity, or iii) both; (4) displaying, by the specifically programmed computer system, at least one first indication that identifies player's progress in performing: i) such selected routine, ii) such selected activity, or iii) both; (5) generating, by the specifically programmed computer system, to the player, at least one first feedback based on the player's progress in performing: i) such selected routine, ii) such selected activity, or iii) both; (6) automatically removing, by the specifically programmed computer system, a completed routine or a completed activity from an associated Y subarea; where the completed routine is such selected routine which the player has performed a pre-determined number of times in accordance with the at least one first performance condition associated with such selected routine; where the completed activity is such selected activity which the player has performed in accordance with the at least one second performance condition associated with such selected activity; (7) allowing, by the specifically programmed computer system, the player to select a new routine, a new activity, or both, from the pool of available X panes; (8) moving, by the specifically programmed computer system, the new routine or the new activity into each Y subarea which has been freed when the specifically programmed computer system removed the completed routine or the completed activity; and (9) repeating, by the specifically programmed computer system, steps (1) through (8) based on the player's desire or until there are no more available X panes.

In some embodiments, the at least one first routine, the at least one first activity, or both, are configured to result in controlling a physical weight of the player. In some embodiments, the first visual area and the second visual area of the game are displayed on a screen of a mobile electronic device of the player.

In some embodiments, the game can further includes: awarding, by the specifically programmed computer system, at least one reward to the player based at least in part on one of the following: i) the at least one first performance condition associated with such selected routine, ii) the at least one second performance condition associated with such selected activity, iii) the player's progress in performing: a) such selected routine, b) such selected activity, or c) both; iv) the completed routine, v) the completed activity, vi) first historical game data associated with the player and such selected routine, and vii) second historical game data associated with the player and such selected activity.

In some embodiments, the at least one reward includes at least one of the following: a first membership discount for a first membership with at least one first business which is associated with the game, a second membership discount for a second membership with at least one second business which is not associated with the game, at least one first membership reward unit associated with the first membership with the at least one first business, at least one second membership reward unit associated with the second membership with the at least one second business, at least one gift card, a monetary cash amount, at least one prepaid debit card, at least one travel discount, at least one discounted athletic equipment, at least one free athletic equipment, at least one discounted prepared food, at least one free prepared food, at least one sweepstakes entry, at least one visual badge, and at least one public recognition identification.

In some embodiments, the at least one first membership reward unit, the at least one second membership reward unit, or both, are quantified in traveled miles or loyalty points. In some embodiments, the at least one first feedback is at least one positive reinforcement signal. In some embodiments, the at least one positive reinforcement signal is at least one of the following: i) at least one written positive statement, ii) at least one verbal positive statement, and iii) at least one visual signal.

In some embodiments, the first number is three. In some embodiments, the first number is between three and seven.

In some embodiments, the instant invention provides for a specially programmed computer system that includes at least the following components: at least one specialized computer machine that includes: a non-transient memory having at least one region for storing particular computer executable program code; and at least one processor for executing the particular program code stored in the memory, where the particular program code is configured so that the at least one specialize computer machine is configured to at least perform the following operations for conducting interactive lifestyle reinforcement game: (1) displaying, by a specifically programmed computer system, to a player, a first visual area and a second visual area of the game; where the first visual area includes a first plurality of X panes, where each X pane includes: i) at least one first description of at least one first routine that the player can select to perform, or ii) at least one second description of at least one first activity that the player can select to perform; where the second visual area includes Y subareas, and where a first number of Y subareas is less than a second number of the first plurality of X panes; (2) moving, by the specifically programmed computer system, each X pane selected by the player into one of the Y subareas of the second visual area until all Y subareas are filled with the player's selected X panes; (3) periodically and automatically requesting, by the specifically programmed computer system, from the player, to confirm that the player has performed each selected routine, each selected activity, or both; where a frequency of requesting depends, at least in part, on: i) at least one first performance condition associated with such selected routine, ii) at least one second performance condition associated with such selected activity, or iii) both; (4) displaying, by the specifically programmed computer system, at least one first indication that identifies player's progress in performing: i) such selected routine, ii) such selected activity, or iii) both; (5) generating, by the specifically programmed computer system, to the player, at least one first feedback based on the player's progress in performing: i) such selected routine, ii) such selected activity, or iii) both; (6) automatically removing, by the specifically programmed computer system, a completed routine or a completed activity from an associated Y subarea; where the completed routine is such selected routine which the player has performed a pre-determined number of times in accordance with the at least one first performance condition associated with such selected routine; where the completed activity is such selected activity which the player has performed in accordance with the at least one second performance condition associated with such selected activity; (7) allowing, by the specifically programmed computer system, the player to select a new routine, a new activity, or both, from the pool of available X panes; (8) moving, by the specifically programmed computer system, the new routine or the new activity into each Y subarea which has been freed when the specifically programmed computer system removed the completed routine or the completed activity; and (9) repeating, by the specifically programmed computer system, the operations (1) through (8) based on the player's desire or until there are no more available X panes.

### BRIEF DESCRIPTION OF THE FIGURES

The present invention can be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

FIG. 1 is an illustrative computer architecture of some embodiments of the present invention.

FIG. 2 is another illustrative computer architecture of some embodiments of the present invention.

FIGS. 3-33 screenshots representative of some embodiments of the present invention.

In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention can become apparent from the following description taken in conjunction with the accompanying figures. Detailed embodiments of the present invention are disclosed herein; however, it is to be understood that the disclosed embodiments are merely illustrative of the invention that may be embodied in various forms, In addition, each of the examples given in connection with the various embodiments of the invention which arc intended to be illustrative, and not restrictive.

### DETAILED DESCRIPTION OF INVENTION

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though they may. Furthermore, the phrases “in another embodiment” and “in some other embodiments” as used herein do not necessarily refer to a different embodiment, although they may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In some embodiments, the term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. In some embodiments, the term “data” as used to represent pre-determined information in one physical non-transient form shall be deemed to encompass any and all representations of corresponding information in a different physical form or forms.

In some embodiments, the term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a list or in any other suitable form.

In some embodiments, the term “network” as used herein includes both networks and internetworks of all kinds, including the Internet, and is not limited to any particular network or inter-network. For example, “network” includes those that are implemented using wired links, wireless links or any combination of wired and wireless links.

In some embodiments, the terms “first”, “second”, “primary” and “secondary” are used to distinguish one element, set, data, object, step, process, activity or thing from another, and are not used to designate relative position or arrangement in time, unless otherwise stated explicitly.

In some embodiments, the terms “coupled”, “coupled to”, “coupled with,” “connected”, and “connected with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means, (b) a communication relationship, whether direct or through one or more other devices, apparatus, files, circuits, elements, functions, operations, processes, programs, media, components, networks, systems, subsystems, or means, and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

In some embodiments, the terms “communicate,” “communicating” and “communication” as used herein include both conveying data from a source to a destination, and delivering data to a communication medium, system, channel, network, device, wire, cable, fiber, circuit and/or link to be conveyed to a destination. The term “communications” as used herein includes one or more of a communication medium, system, channel, network, device, wire, cable, fiber, circuit and link.

In some embodiments, the term “processor” as used herein means processing devices, apparatus, programs, circuits, components, systems and subsystems, whether implemented in hardware, software or both, and whether or not programmable. In some embodiments, the term “processor” as used herein includes, but is not limited to one or more computers, hardwired circuits, neural networks, signal modifying devices and systems, devices and machines for controlling systems, central processing units, programmable devices and systems, field programmable gate arrays, application specific integrated circuits, systems on a chip, systems included of discrete elements and/or circuits, state machines, virtual machines, data processors, processing facilities and combinations of any of the foregoing.

In some embodiments, the term “data processing system” as used herein means a system implemented at least in part by hardware and comprising a data input device, a data output device and a processor coupled with the data input device to receive data therefrom and coupled with the output device to provide processed data thereto.

In some embodiments, the terms “obtain”, “obtained” and “obtaining”, as used with respect to a processor or data processing system mean (a) producing data by processing data, (b) retrieving data from storage, or (c) requesting and receiving data from a further data processing system.

In some embodiments, the terms “storage” and “data storage” as used herein mean one or more data storage devices, apparatus, programs, circuits, components, systems, subsystems, locations and storage media serving to retain data, whether on a temporary or permanent basis, and to provide such retained data.

The terms “amount” and “amounts” as used herein refer both to absolute and relative measures.

It is understood that at least one aspect/functionality of the various embodiments described herein can be performed in real-time (or “in real time”) and/or dynamically. As used herein, the term “real-time”/“in real time” means that an event/action occurs instantaneously or almost instantaneously in time when another event/action has occurred. As used herein, the term “dynamic(ly)” means that an event/action occurs without any human intervention.

### Illustrative Operating Environments

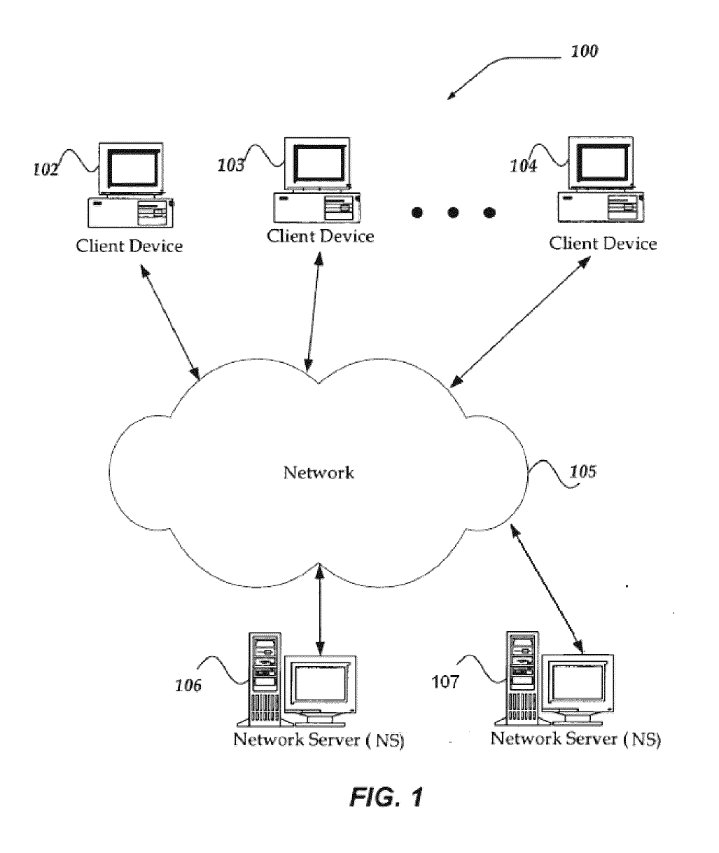

FIG. 1 illustrates one embodiment of an environment in which the present invention may operate. However, not all of these components may be required to practice the invention, and variations in the arrangement and type of the components may be made without departing from the spirit or scope of the invention. In some embodiments, the instant invention can host a large number of persons and concurrent transactions. In other embodiments, the instant invention can be based on a scalable computer and network architecture that incorporates varies strategies for assessing the data, caching, searching, and database connection pooling. An example of the scalable architecture is an architecture that is capable of operating multiple servers.

In embodiments, persons' computer devices 102-104 include virtually any computing device capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, persons' computer devices 102-104 are any device that is capable of connecting using a wired or wireless communication medium such as a PDA, POCKET PC, wearable computer, and any other device that is equipped to communicate over a and/or wireless communication medium.

In some embodiments, each person's computer device within client devices 102-104 can include a browser application that is configured to receive and to send web pages, and the like. In embodiments, the browser application is configured to receive and display graphics, text, multimedia, and the like, employing virtually any web based language, including, but not limited to Standard Generalized Markup Language (SGML), such as HyperText Markup Language (HTML), a wireless application protocol (WAP), a Handheld Device Markup Language (HDML), such as Wireless Markup Language (WML), WMLScript, JavaScript, and the like. In embodiments, persons' computer devices 102-104 can be programmed in either Java or .Net.

In some embodiments, persons' computer devices 102-104 are further configured to receive a message from the another computing device employing another mechanism, including, but not limited to email, Short Message Service (SMS), Multimedia Message Service (MMS), instant messaging (IM), internet relay chat (IRC), mIRC, Jabber, and the like.

In some embodiments, network 105 is configured to couple one computing device to another computing device to enable them to communicate. In embodiments, network 105 is enabled to employ any form of computer readable media for communicating information from one electronic device to another. Also, in embodiments, network 105 includes a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router acts as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, integrated Services Digital Networks (ISDNs), Digital Subscriber Lines (DSLs), wireless links including satellite links, or other communications links known to those skilled in the art. Furthermore, in embodiments, remote computers and other related electronic devices could be remotely connected to either LANs or WANs via a modem and temporary telephone link. In essence, in embodiments, network 105 includes any communication method by which information may travel between client devices 102-104, and servers 106 and 107.

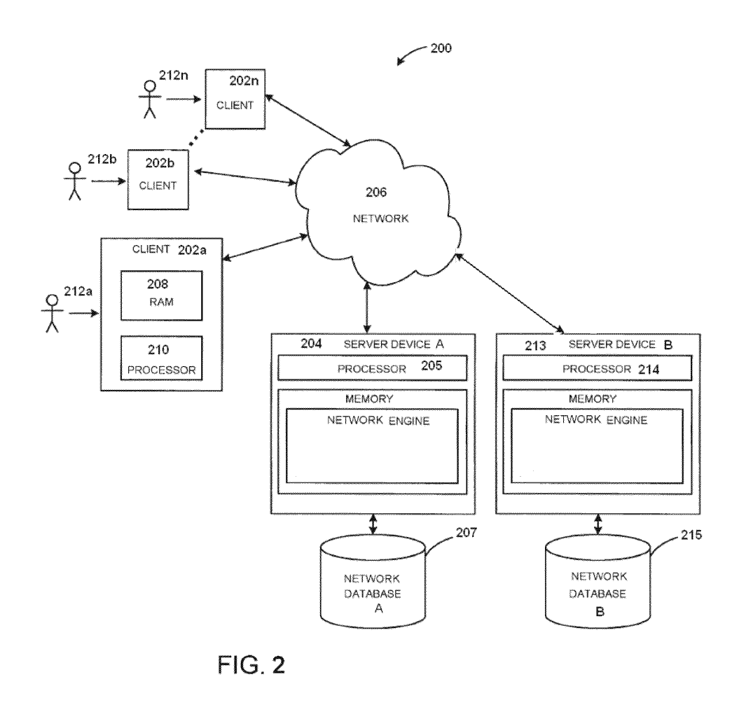

FIG. 2 shows the computer and network architecture of some embodiments of the instant invention. The persons' computer devices 202a, 202b thru 202n shown, each includes a computer-readable medium, such as a random access memory (RAM) 208 coupled to a processor 210. The processor 210 executes computer-executable program instructions stored in memory 208. Such processors include a microprocessor, an ASIC, and state machines. Such processors include, or are in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 210 of client 202a, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media transmit or carry instructions to a computer, including a router, private or public network, or other transmission device or channel, both wired and wireless. The instructions include code from any computer-programming language, including, for example, C, C++, C#, Visual Basic, Java, Python, Perl, and JavaScript.

The persons' computer devices 202a-n can also include a number of external or internal devices such as a mouse, a CD-ROM, DVD, a keyboard, a display, or other input or output devices. Examples of persons' computer devices 202a-n are personal computers, digital assistants, personal digital assistants, cellular phones, mobile phones, smart phones, pagers, digital tablets, laptop computers, Internet appliances, and other processor-based devices. In general, a person device 202a are any type of processor-based platform that is connected to a network 206 and that interacts with one or more application programs. The persons' computer devices 202a-n operate on any operating system capable of supporting a browser or browser-enabled application, such as Microsoft™, Windows™, or Linux. The persons' computer devices 202a-n shown include, for example, personal computers executing a browser application program such as Microsoft Corporation's Internet Explorer™, Apple Computer, Inc.'s Safari™, Mozilla Firefox, and Opera.

Through the persons' computer devices 202a-n, persons 212a-n of the instant invention can communicate over the network 206 with a centralized computer system, and/or each other, and/or with other ystems and devices coupled to the network 206. As shown in FIG. 2, server devices 204 and 213 are also coupled to the network 206.

In some embodiments, the instant invention can utilize NFC technology to obtain/transmit information. In some embodiments, NFC can represent a short-range wireless communications technology in which NFC-enabled devices are “swiped,” “bumped,” “tap” or otherwise moved in close proximity to communicate. In some embodiments, NFC could include a set of short-range wireless technologies, typically requiring a distance of 10 cm or less. In some embodiments, NFC can operate at 13.56 MHz on ISO/IEC 18000-3 air interface and at rates ranging from 106 kbit/s to 424 kbit/s. In some embodiments, NFC can involve an initiator and a target; the initiator actively generates an RF field that can power a passive target. In some embodiment, this can enable NFC targets to take very simple form factors such as tags, stickers, fobs, or cards that do not require batteries. In some embodiments, NFC peer-to-peer communication can be conducted when a plurality of NFC-enable devices are within close proximity of each other.

In some embodiments, NFC tags can contain data and be read-only or rewriteable. In some embodiments, NFC tags can be custom-encoded. In some embodiments, NFC tags and/or NFC-enabled device (e.g., smart phones with NFC capabilities) can securely store personal data such as debit and credit card information, loyalty program data, PINs and networking contacts, and/or other information. NFC tags can be encoded to pass a Uniform Resource Locator (URL) and a processor of the NFC-enabled device can automatically direct a browoor application thereof to the URL without prompting for permission to proceed to the designated location.

In some embodiments, lottery data may also be communicated using any wireless means of communication, such as 4G, 3G, GSM, GPRS, WiFi, WiMax, and other remote local or remote wireless communication using information obtained via the interfacing of a wireless NFC enabled mobile device to another NFC enabled device or a NFC tag. In some embodiments, the term “wireless communications” includes communications conducted at ISO 14443 and ISO 18092 interfaces. In some embodiments, the communications between person's NFC-enabled smart device is performed, for example, in accordance with the ISO 14443A/B standard and/or the ISO 18092 standard.

In some embodiments, person's NFC-enabled smart device provided equipment (e.g., terminals, POS, POE, Hosts) can include one or more additional transceivers (e.g., radio, Bluetooth, and/or WiFi transceivers) and associated antennas, and enabled to communicate with each other by way of one or more mobile and/or wireless protocols. In some embodiments, NFC tags can include one or more integrated circuits.

In some embodiments, person's NFC-enabled smart device may include a cellular transceiver coupled to the processor and receiving a cellular network timing signal. In some embodiments, person's NFC-enabled smart device may further include a satellite positioning receiver coupled to the processor and receiving a satellite positioning system timing signal and the processor may accordingly be configured to synchronize the internal timing signal to the satellite positioning system timing signal as the external timing signal. In some embodiments, the processor of person's NFC-enabled smart device may be configured to synchronize the internal timing signal to the common external system timing signal via the NFC circuit.

In some of embodiments, the exemplary games of the instant invention can be played utilizing at least one of the following devices:
TV/Smart TV;
Smart LCD Panels on anything;
Wearable (e.g., Google Glass, Smart Watches);
Video Game Consoles (X-Box Playstation, Wii, etc);
Living Room Consoles with Smart-Add-Ons (e.g., Roku);
an embedded system;
Scales;
Robots;
Refrigerators;
Ingestible/insertable devices;
Medical devices (e.g., blood pressure monitor, glucose monitor, etc); and
other similarly suitable device(s).

For purposes of some embodiments, the term “game piece” means either physical form or electronic presentation which are representative of at leas some data required for participation in a game. In some embodiments, all game pieces are rendered in physical form. In some embodiments, all game pieces are rendered in electronic representation form. In some embodiments, at least one game piece of the game is in physical form and at least one game piece of the game is in electronic representation form. In some embodiments, the game pieces are displayed on a computing device.

For purposes of some embodiments, the term “indicia” means visible and/or invisible representations of game data on a game piece. In some embodiments, the term “indicia” can include game data that includes, but is not limited to, illustrations and/or characters describing and/or showing an activity and/or routine, number(s), character(s), geometrical shapes, playing cards, dice, game boards, and/or combination(s) thereof.

In some embodiments, the game data may include activities related to one or more “spaces” and/or one or more “routines”. In some embodiments, the one or more “spaces” include, but are not limited to, categories such as home, shopping, workplace, eating out, travel and/or occasions. In some embodiments, each category of “spaces” includes subcategories. In an example, the “home” category may include subcategories including, but not limited to, a kitchen, living room, media room, bedroom, and/or other room of a home. In some embodiments, the subcategory may include, but is not limited to, one or more activities. In an example, the subcategory of “kitchen”, the activities may include, but are not limited to, “declutter your countertops”, “reorganize your fridge”, and/or “bring order to your pantry”.

In some embodiments, the one or more “routines” include, but are not limited to, “wear an activity monitor all day, every day”, “eat breakfast every day”, “before eating anything, ask yourself if it is worth the PPV”, “eat all your meals at a table”, “put your fork down or take a sip of water after”, “identify tasks you now do sitting and do them standing or pacing”, “get 7-8 hours of quality sleep every night”, and/or any other routine adapted to improve a person's overall health.

In some of embodiments, the exemplary routines of the instant invention can include routine(s) of at least one of the following types of routines:
meals (e.g., eat breakfast every day);
foods (e.g., eat a vegetable at every meal);
stress (e.g., write down your stress level 3 times a day);
sleep (e.g., sleep 8 hours a night);
nutrition (e g., eat your daily recommended dose of vitamin C);
weight (e.g., weigh yourself daily);
health (e.g., record how “healthy” you feel daily);
activity (e.g., walk at least 5 minutes a day);
fitness (e.g., increase the number of sit-ups you can do by 1 every day for a week);
location check-In (e.g., use GPS-connected device to verify that you attended a Weight Watchers meeting once a week);
themed routines:
   1. celebrity routines (e.g., do Jennifer Hudson's favorite routine with her during May)
   2. marketing-oriented routines (e.g., Loose-a-palooze)
   3. charity-oriented routines (e.g., Lose for Good—every routine check-in can help donate to charity)
   4. seasonal-specific routines (e.g., Thanksgiving challenge)
   5. sponsored routines (e.g.: Nike, Progresso, etc.); and
Product (e.g., a combination of routines: Pick 3 Routines when you sign up, and that becomes the Product. So today your “default” Product consists of: Food Tracking, Weight Tracking and Activity Tracking routines).

In some of embodiments, the exemplary routines games of the instant invention can be directed to achieve at least one of the following objectives:
teaching tool (e.g., teaching players a new activity);
habit change (e.g., create, change, learn, and/or break habits);
goal setting (e.g., perform a routine for a pre-determined amount of time (or predetermined amount of repetitions) to achieve a goal: for example, clean one kitchen drawer a day until all the drawers in your kitchen contain healthy food choices); and
use as a planning tool (e.g., perform a small task every day to prepare for a healthy dinner party).

### Illustrative Examples for Conducting Interactive Lifestyle Reinforcement Games of the Present Invention

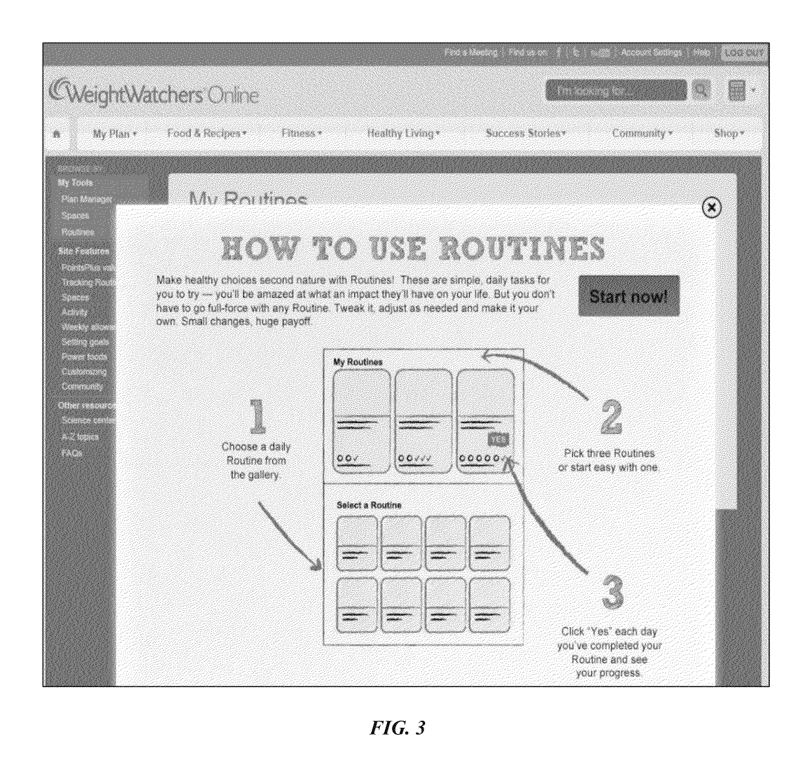

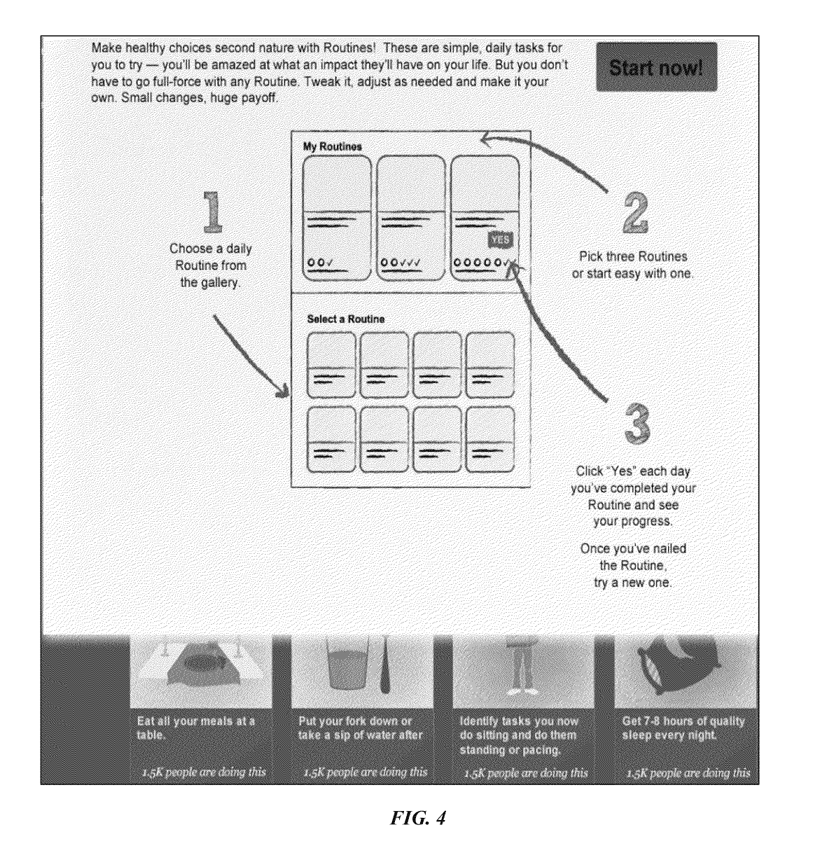

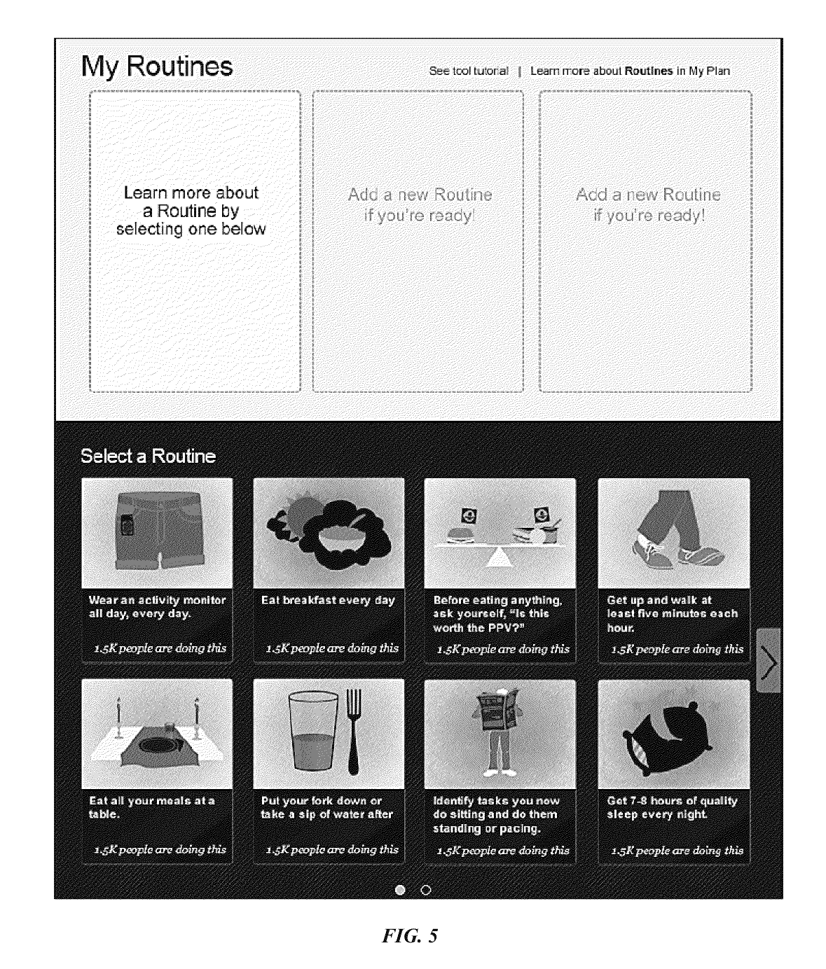

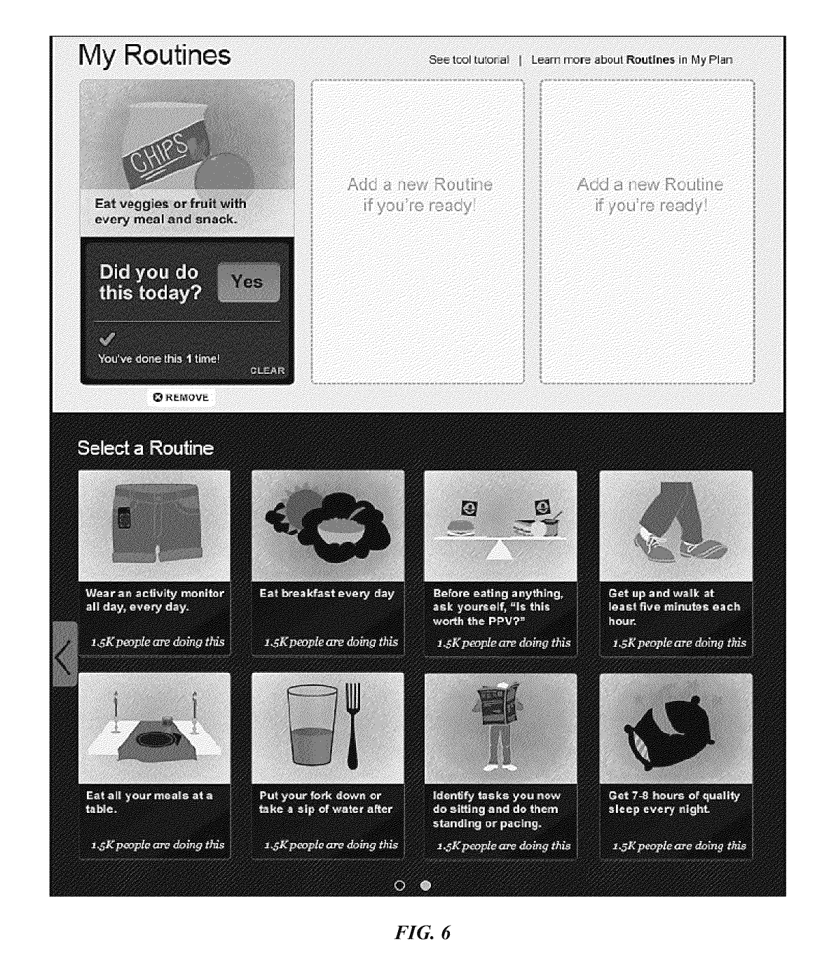

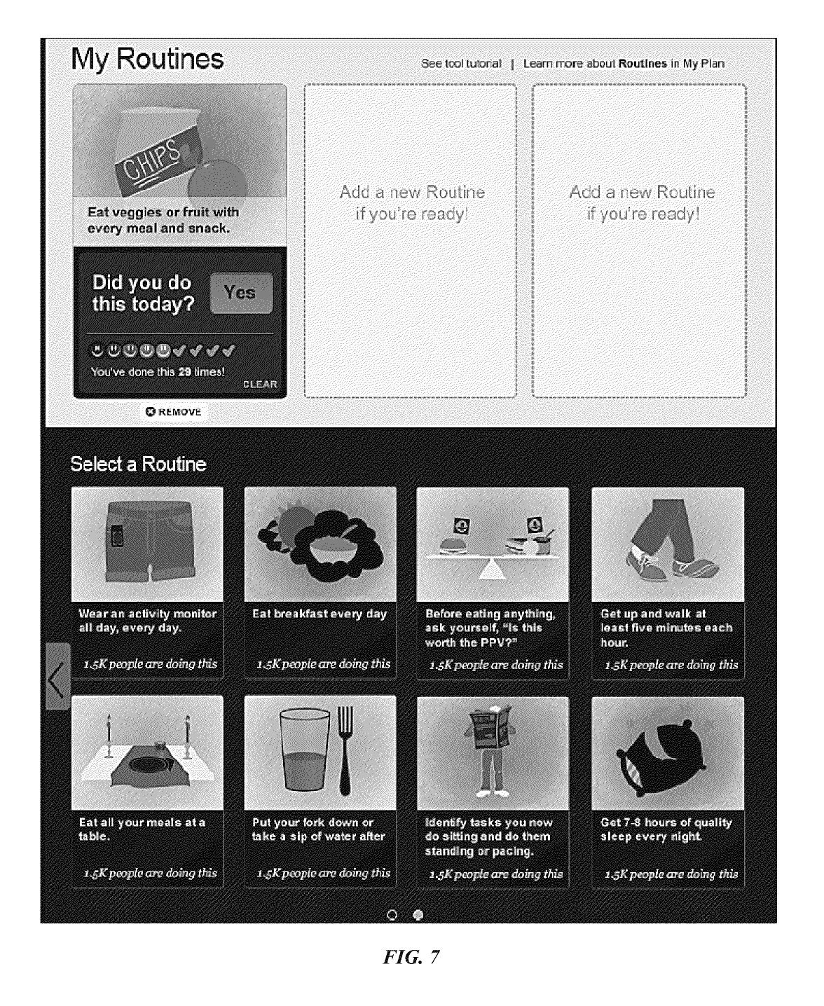

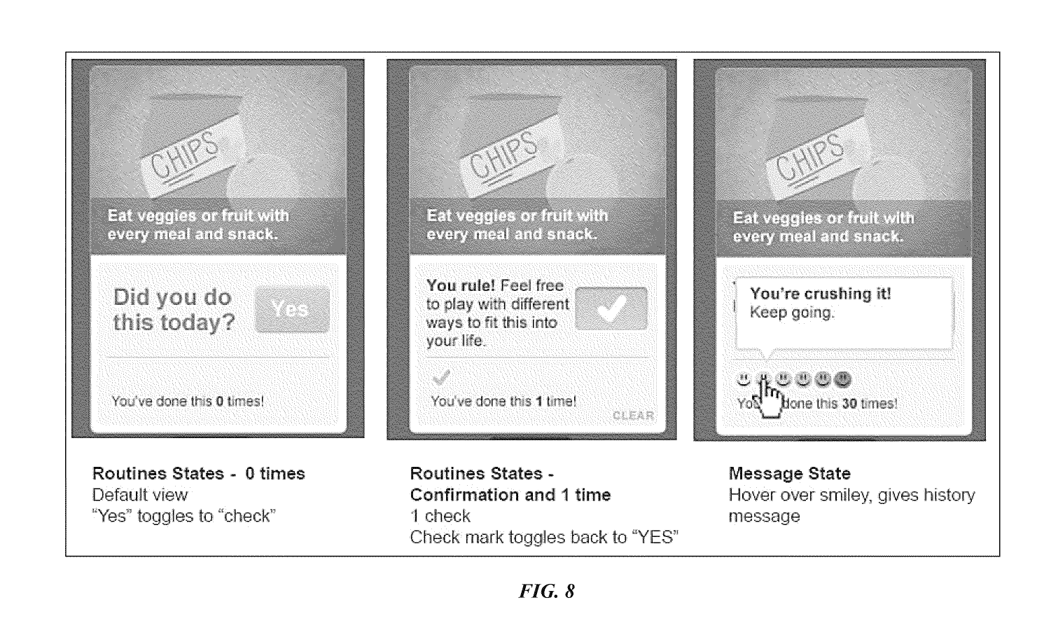

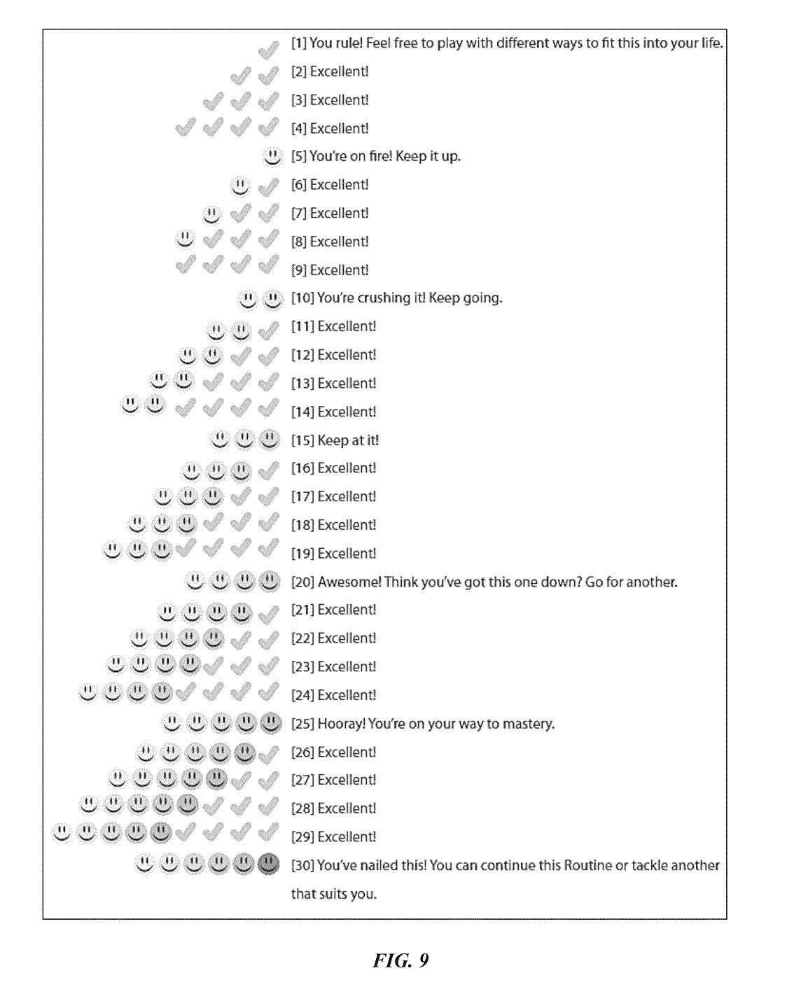

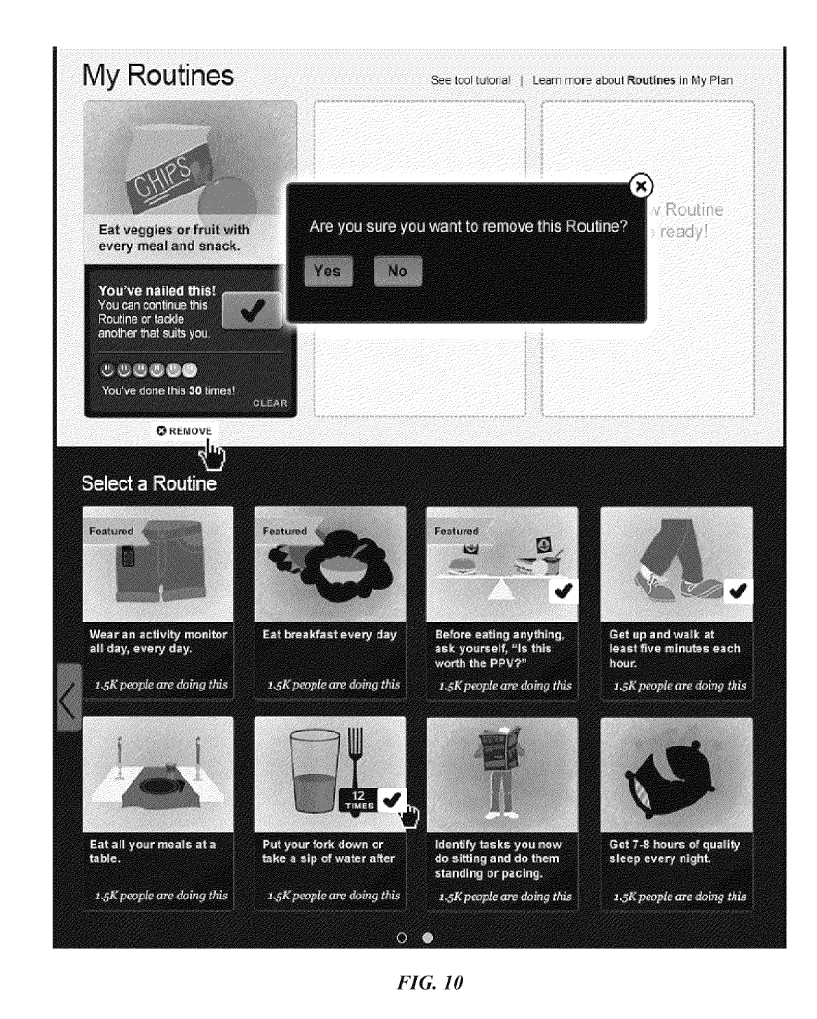

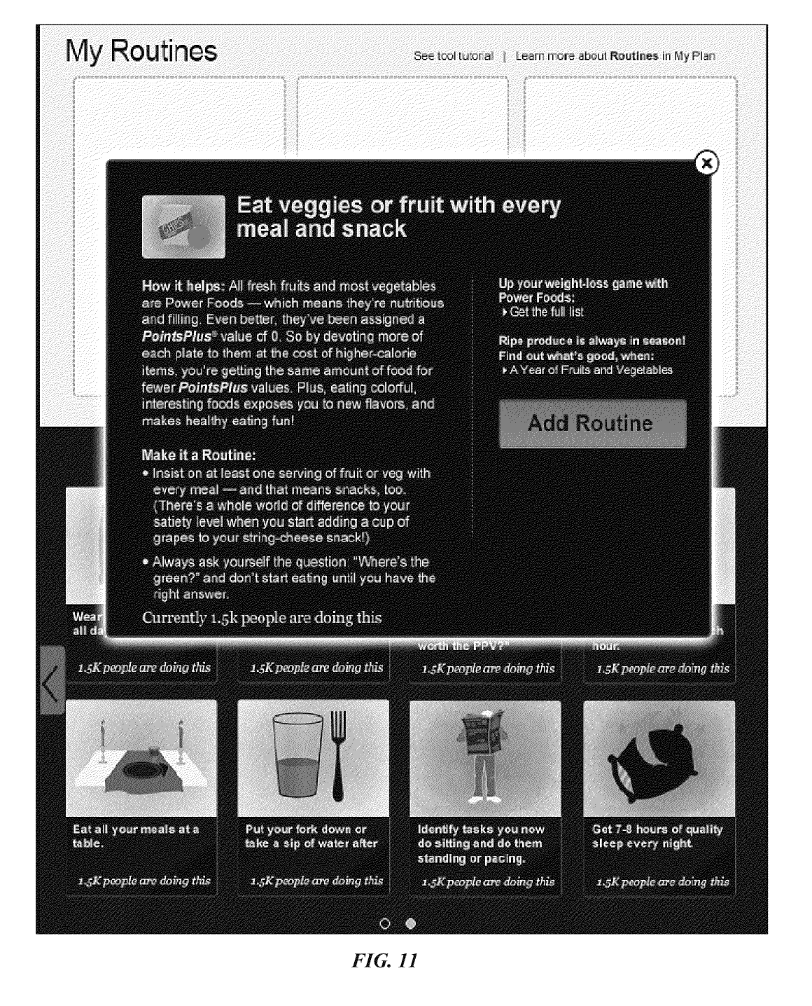

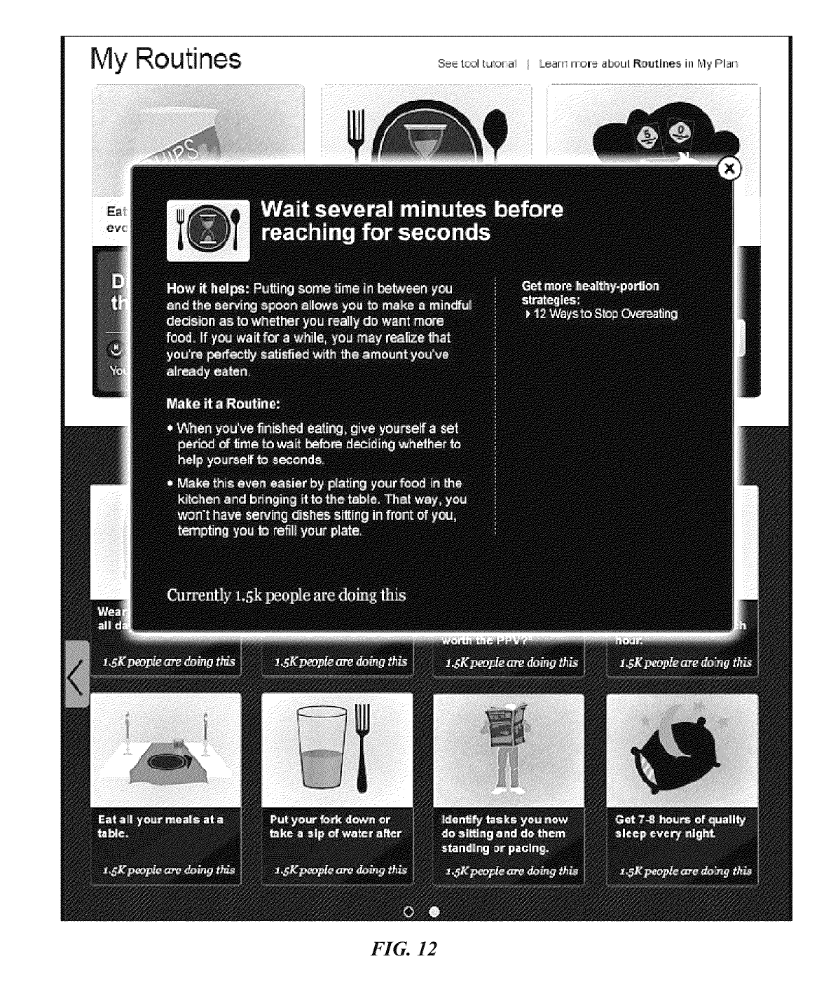

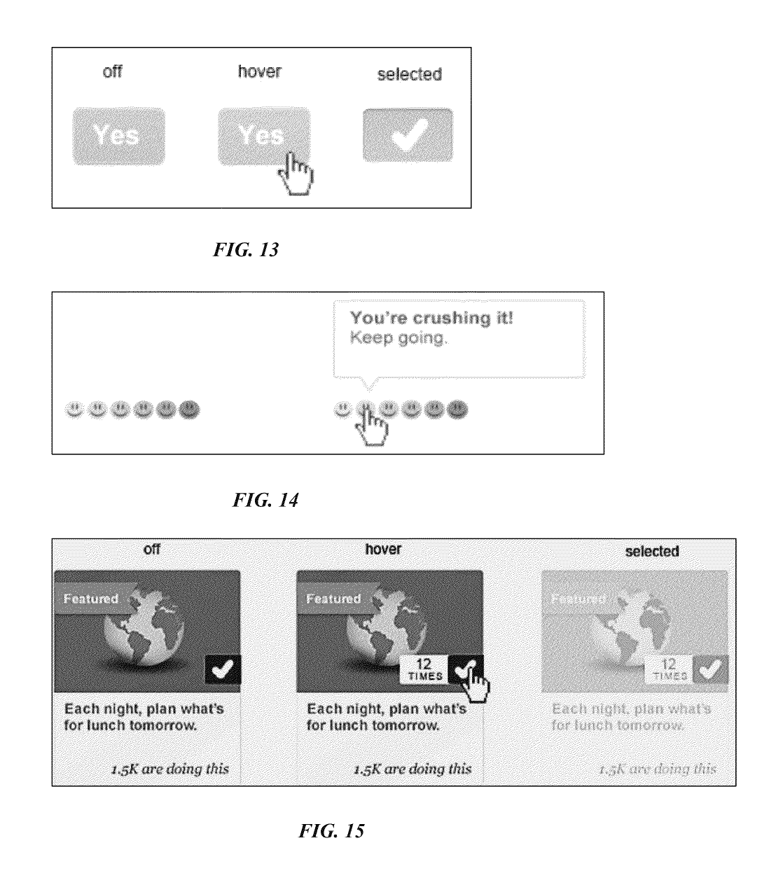

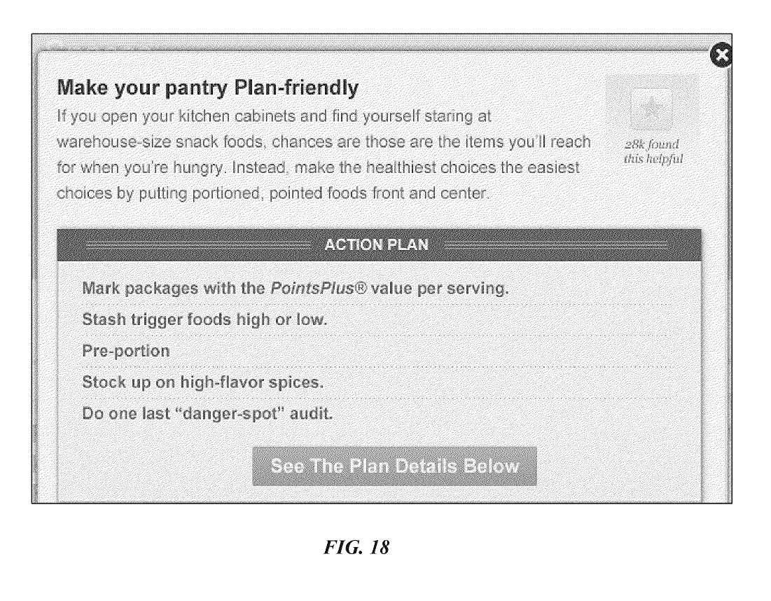

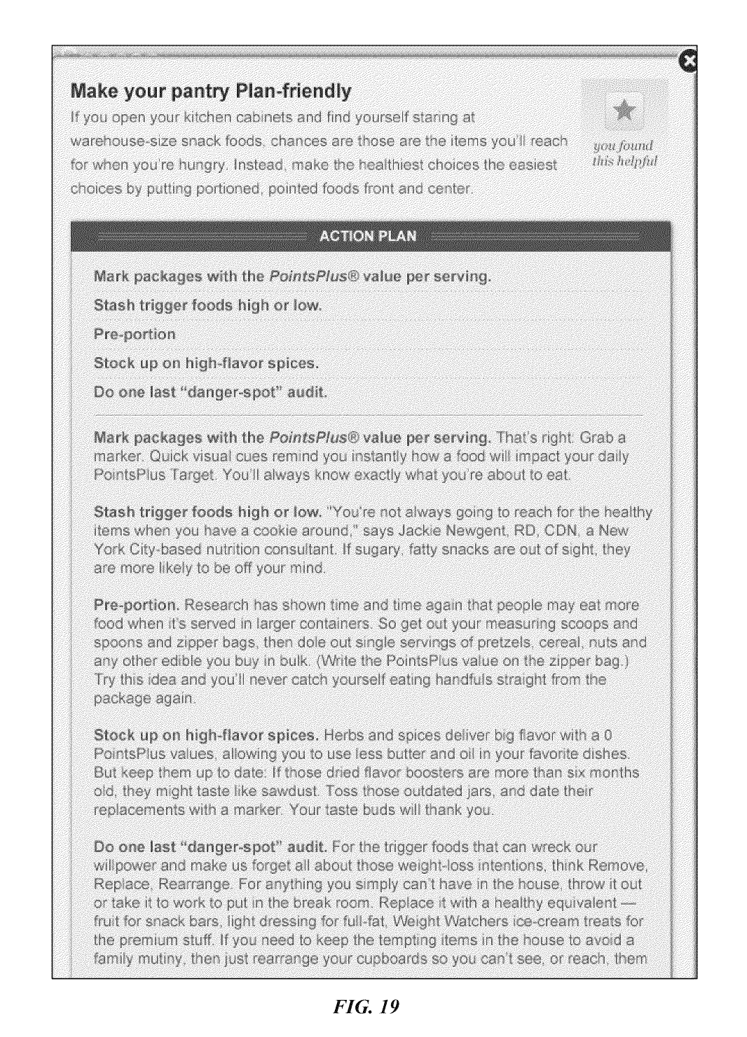

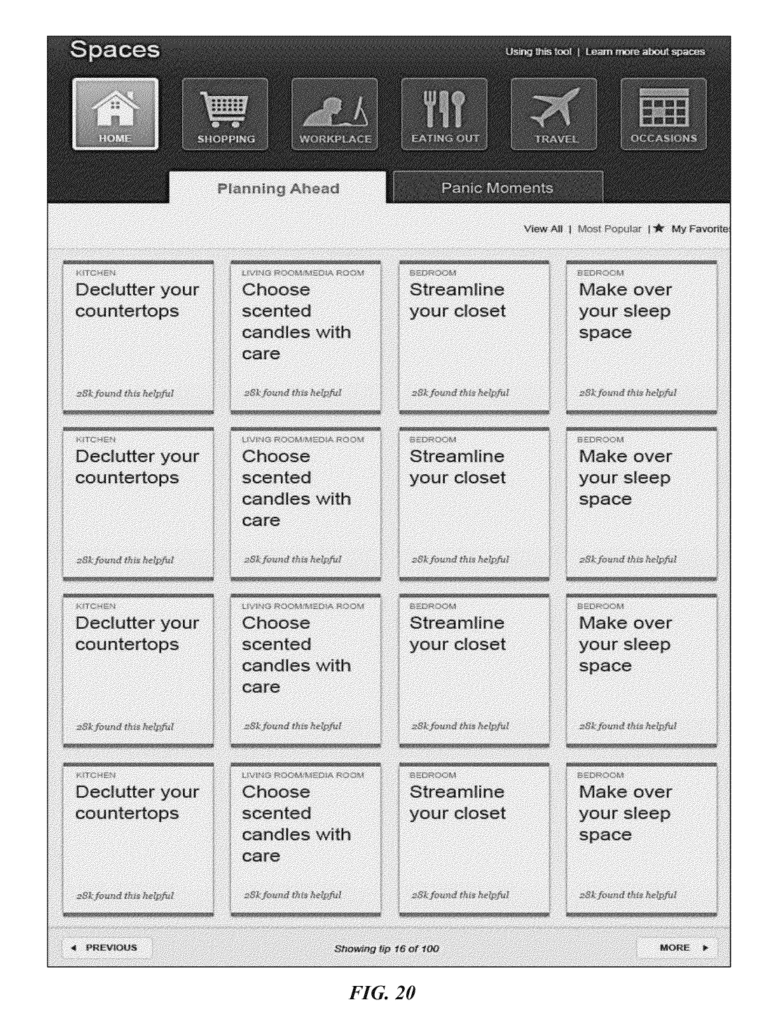

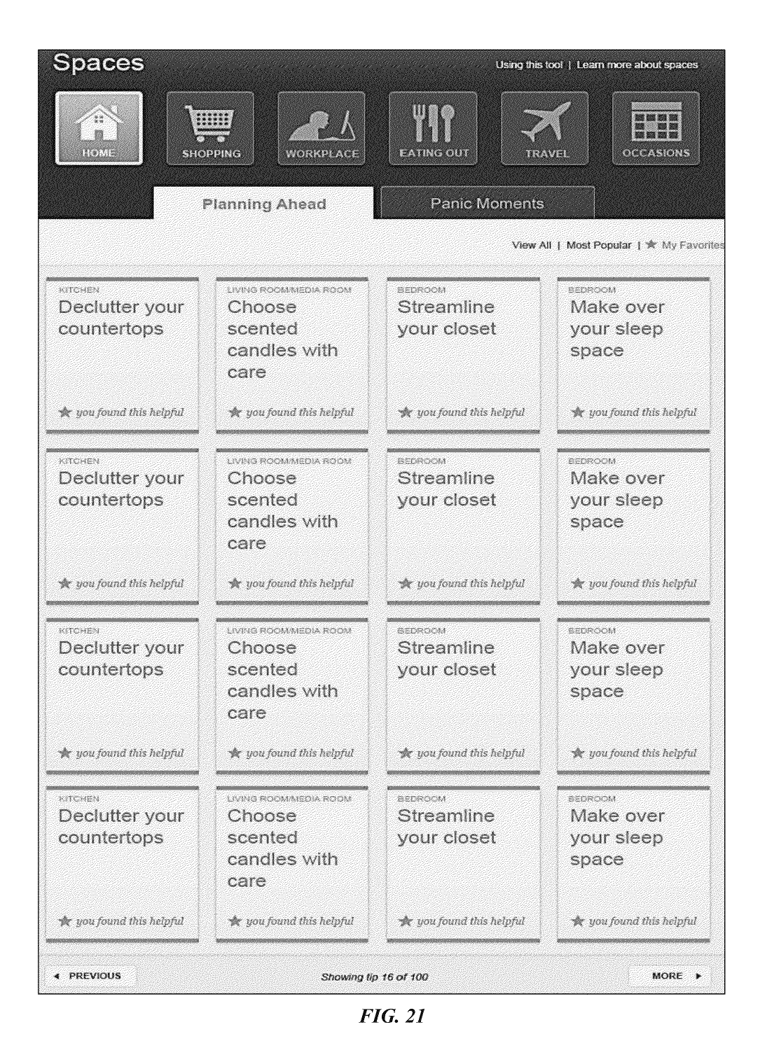

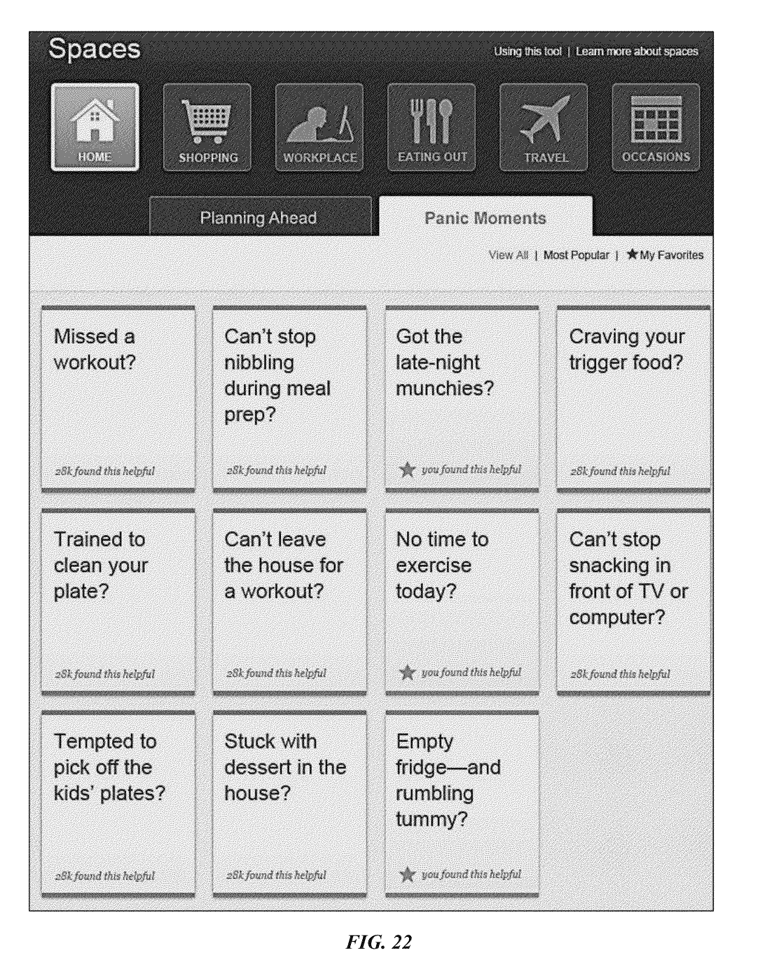

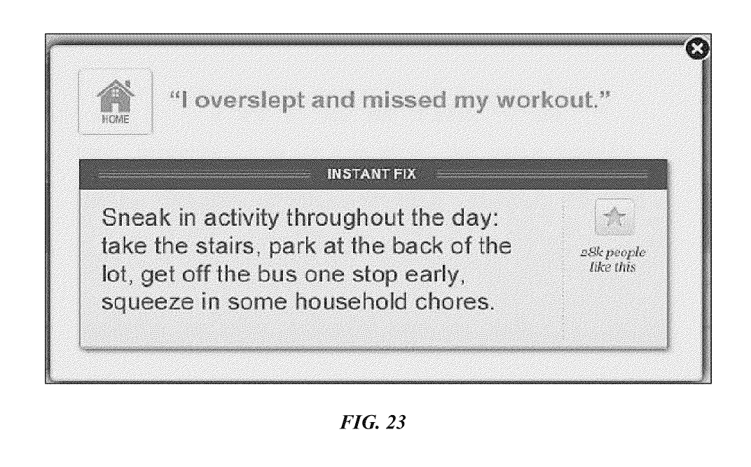

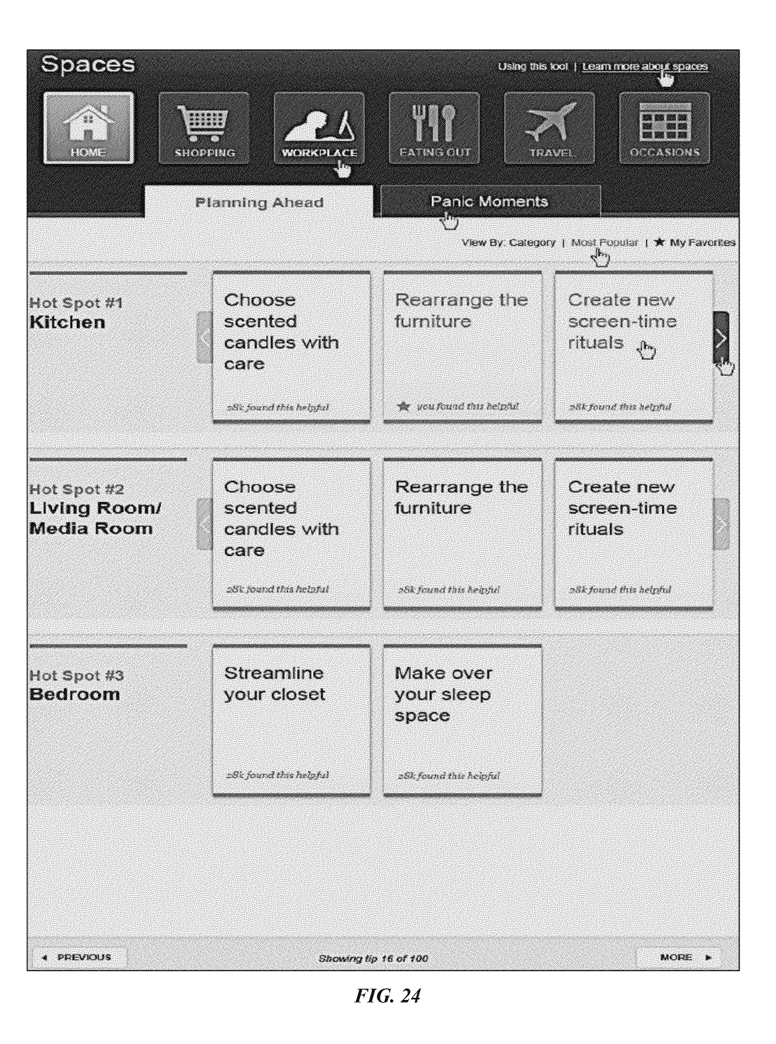

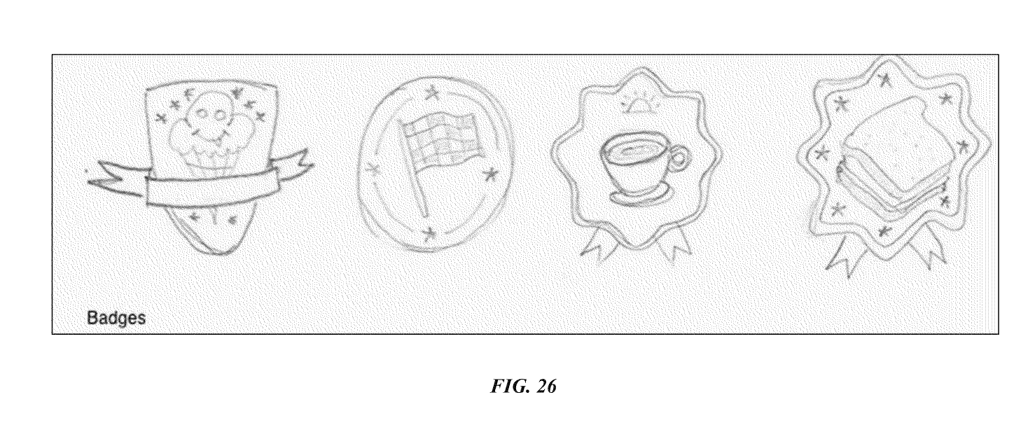

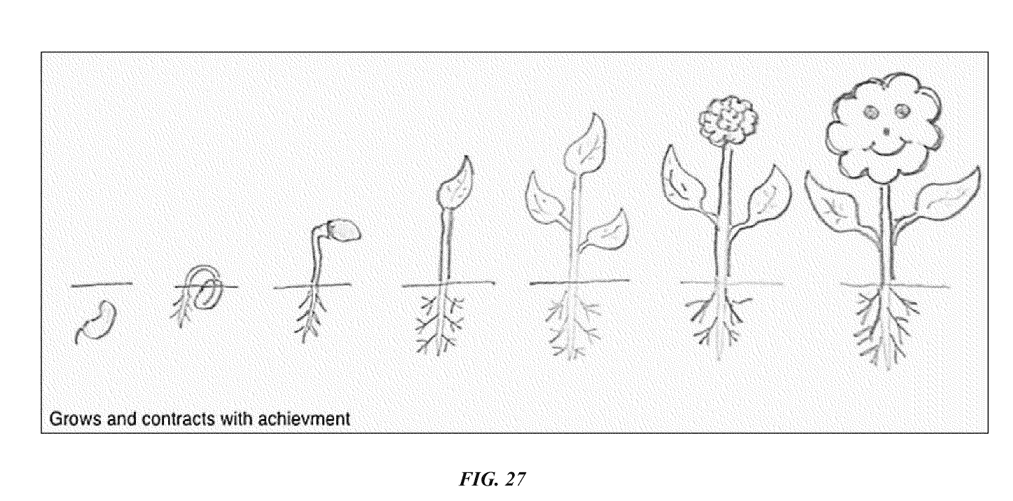

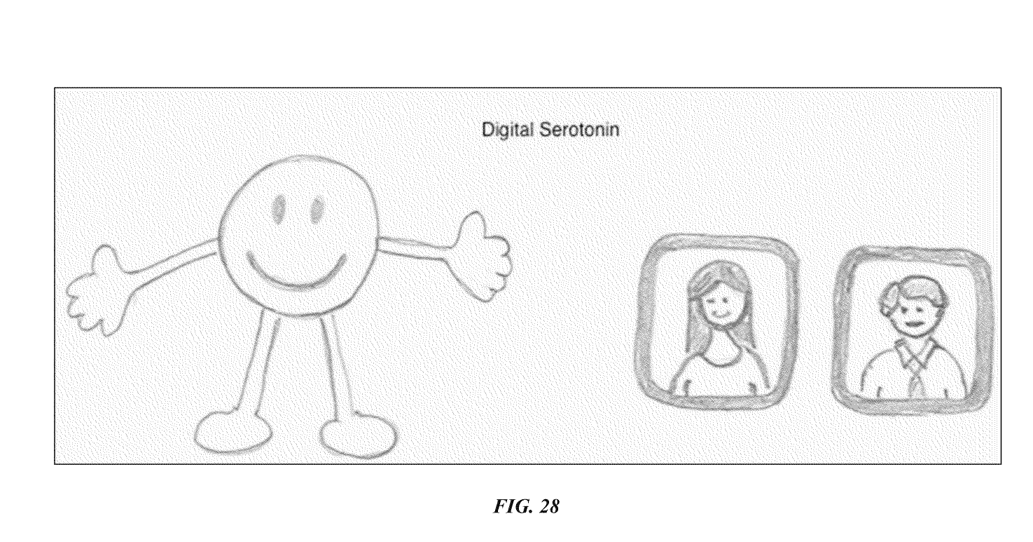

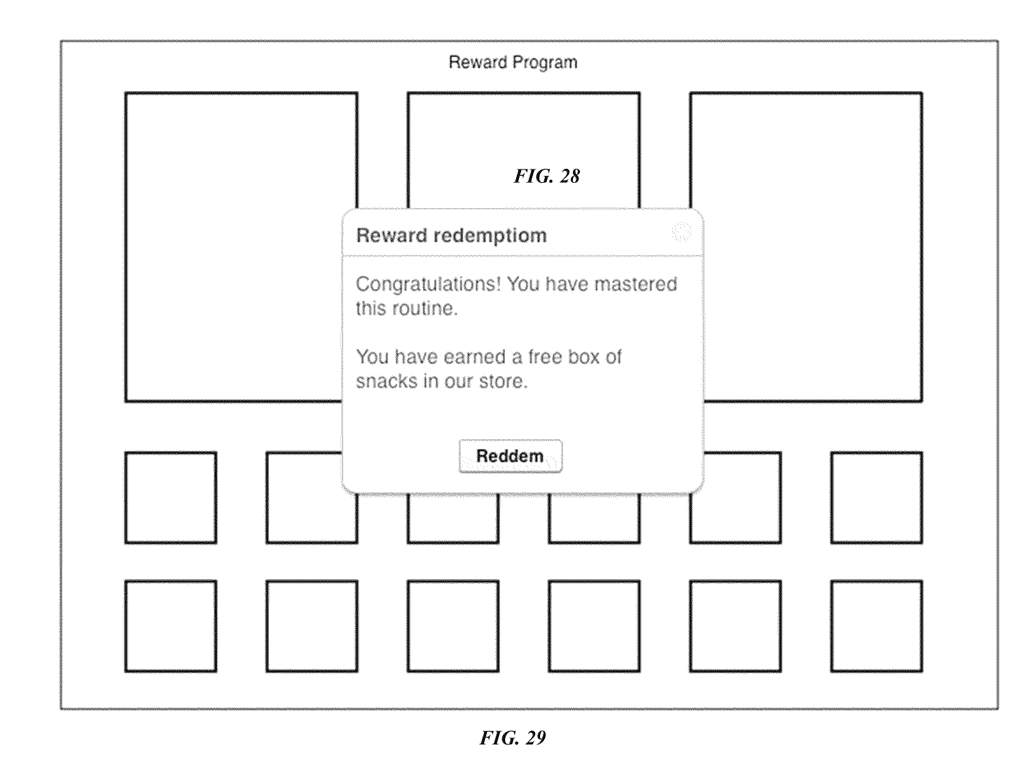

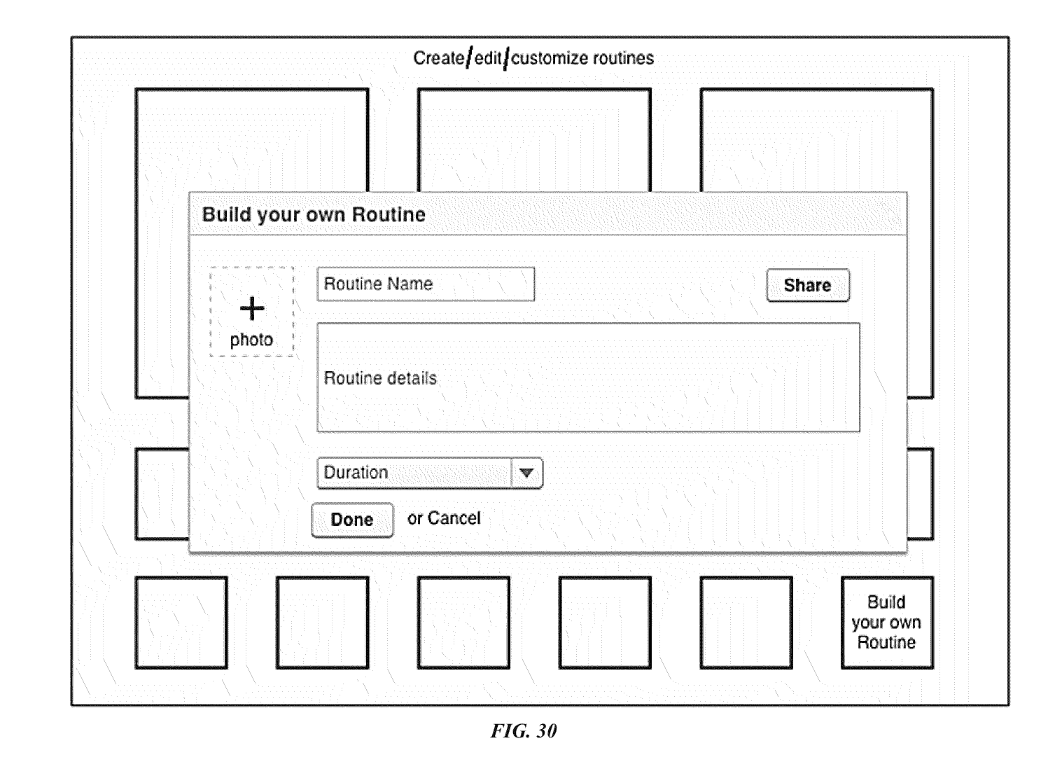

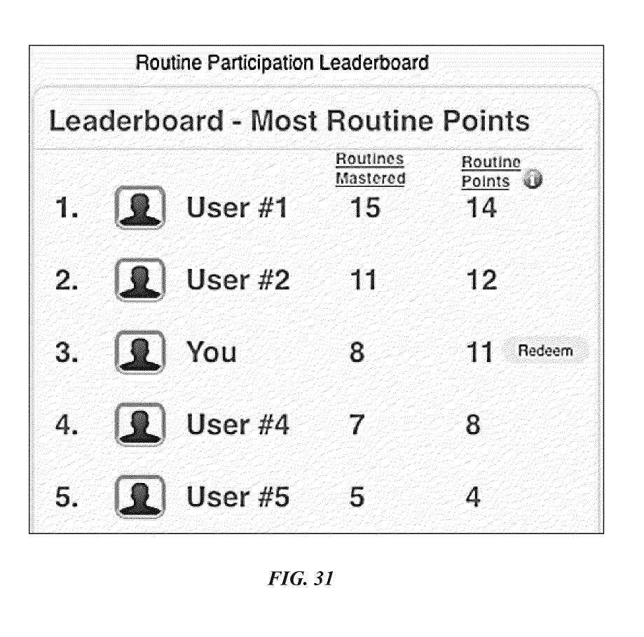

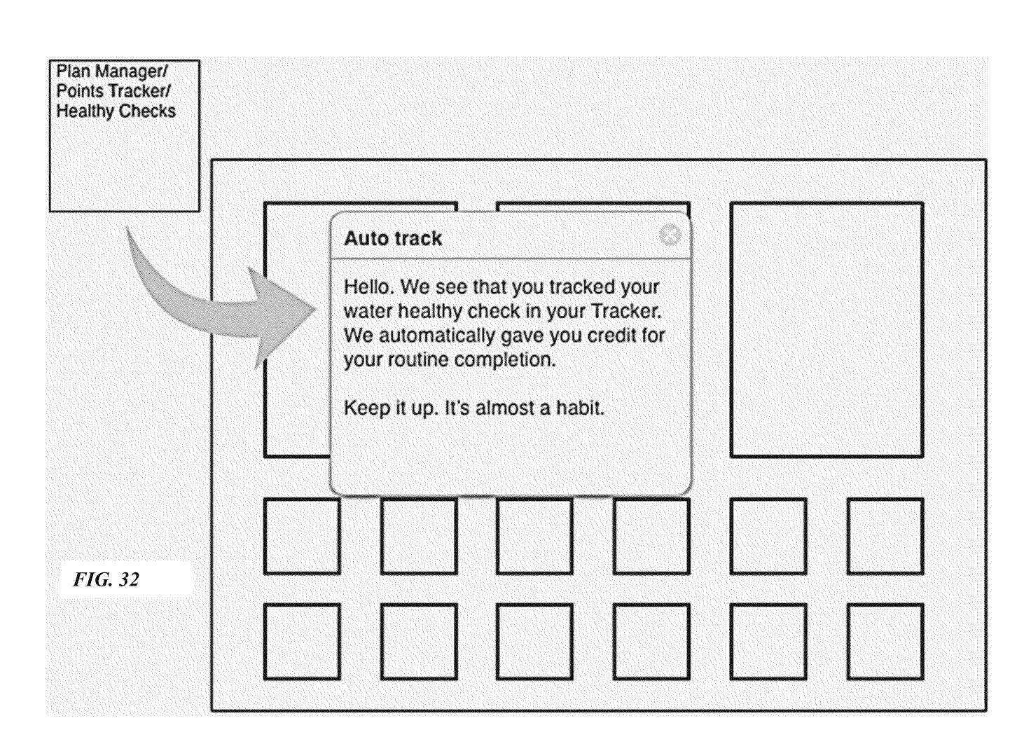

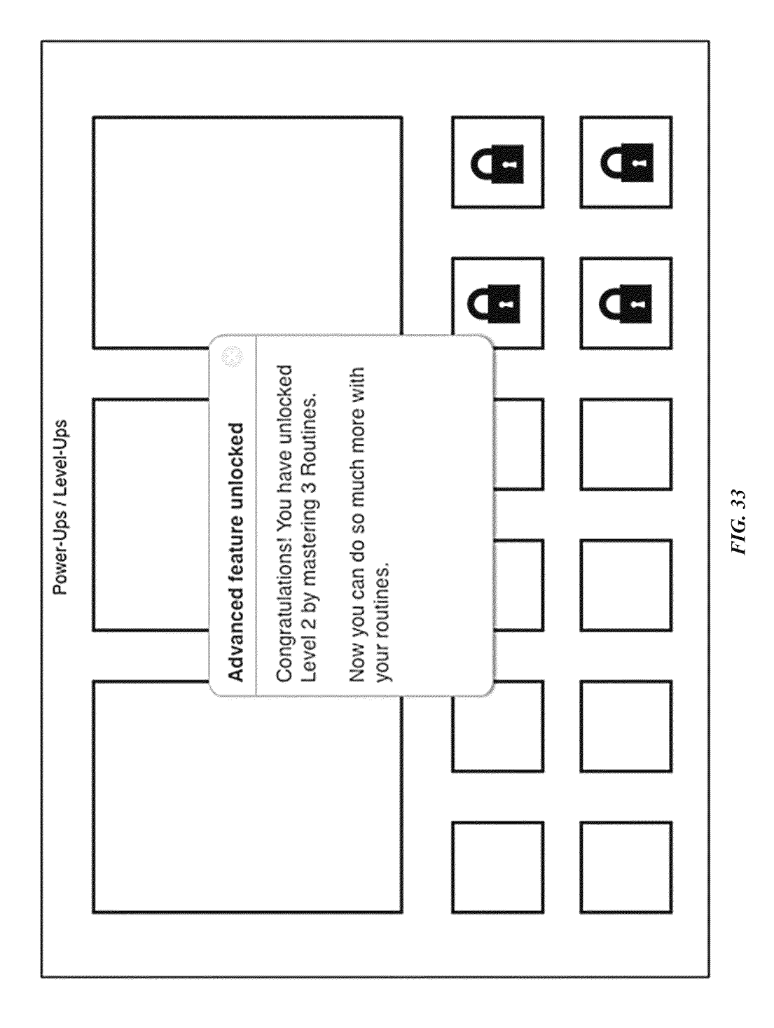

Non-limiting examples of the interactive lifestyle reinforcement games of the present invention are shown in screenshots of FIGS. 3-33.

For example, as shown in the screenshots of FIGS. 3-15 and 25-33, some embodiments of the instant invention include a computer-implemented method having at least a plurality of the following steps:

(1) displaying, by a computer system, to a user, a first visual area and a second visual area of the game, where the displaying is performed on the user's mobile electronic device, where the first visual area includes a plurality of X panes, where each X pane includes a description of a routine that the user can pick to follow, and where the second visual area includes Y subareas, and where the number of Y subareas is less than the number X panes;

(2) moving, by the computer system, each X pane selected by the user into one of the Y subareas of the second visual area until all Y subareas are filled with the user's selected X panes;

(3) periodically and automatically requesting, by the computer system, from the user, to confirm that the user has performed the selected routine, where a frequency of requesting depends on condition(s) associated with the routine;

(4) displaying, by the computer system, at least one indication that identifies user's progress in performing the selected routine;

(5) providing, by the computer system, to the user, a feedback based on the user's progress in performing the selected routine;

(6) automatically removing, by the computer system, a completed routine from the Y subarea, wherein the completed routine is the selected routine which the user has performed a pre-determined number of times which is required by the conditions associated with the selected routine;

(7) allowing, by the computer system, the user to select a new routine from the pool of available X panes; and

(8) moving the new routine into the Y subarea which has been freed when the computer system removed the completed routine;

(9) repeating steps (1) through (8) based on the user's desire or until there are no more available X panes.

In some embodiments, the number of X subareas is at least five. In some embodiments, the number of X subareas is at least ten. In some embodiments, the number of X subareas is at least 50. In some embodiments, the number of X subareas is at least one hundred. In some embodiments, the number of X subareas is between five and fifty. In some embodiments, the number of X subareas is between five and one hundred. In some embodiments, the number of X subareas is between five and five hundred.

In some embodiments, at least one X subarea represents a group of routines/activities and selecting such X subarea results in offering new X subareas for each routine/activity from the group of routines/activities.

In some embodiments, the number of Y subareas is at least three. In some embodiments, the number of Y subareas is at least five. In some embodiments, the number of Y subareas is at least seven. In some embodiments, the number of Y subareas is at least ten. In some embodiments, the number of Y subareas is between three and seven. In some embodiments, the number of Y subareas is between three and ten. In some embodiments, the number of Y subareas is between five and ten.

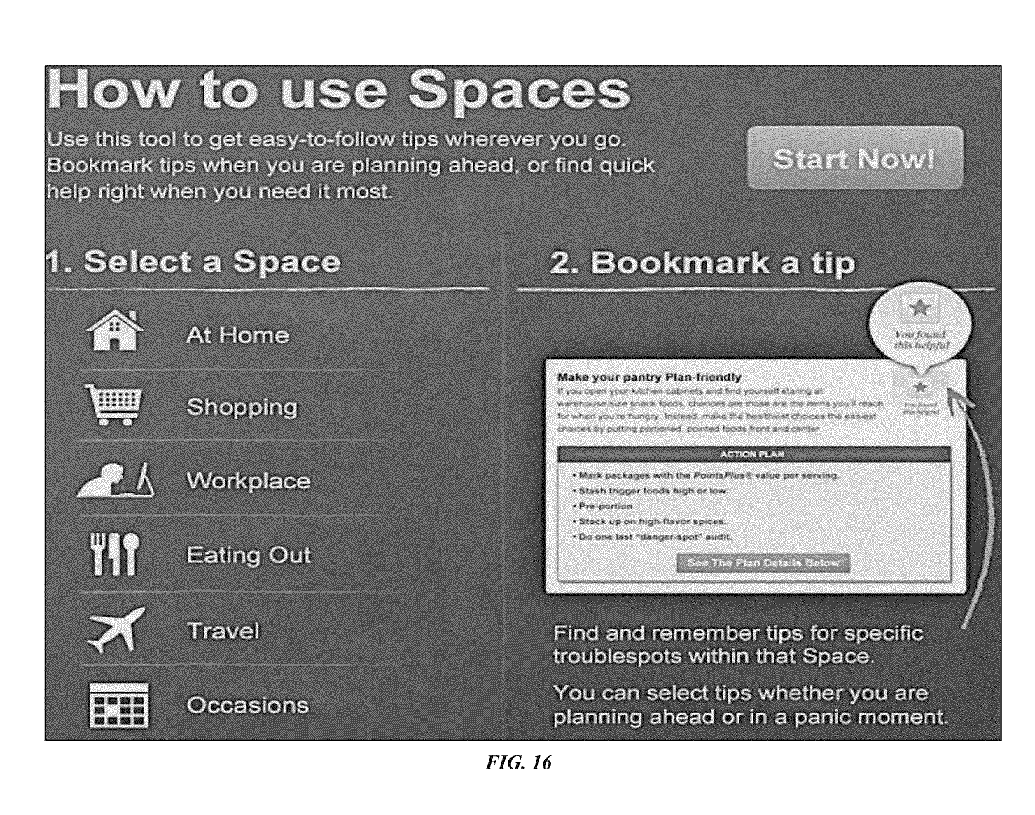

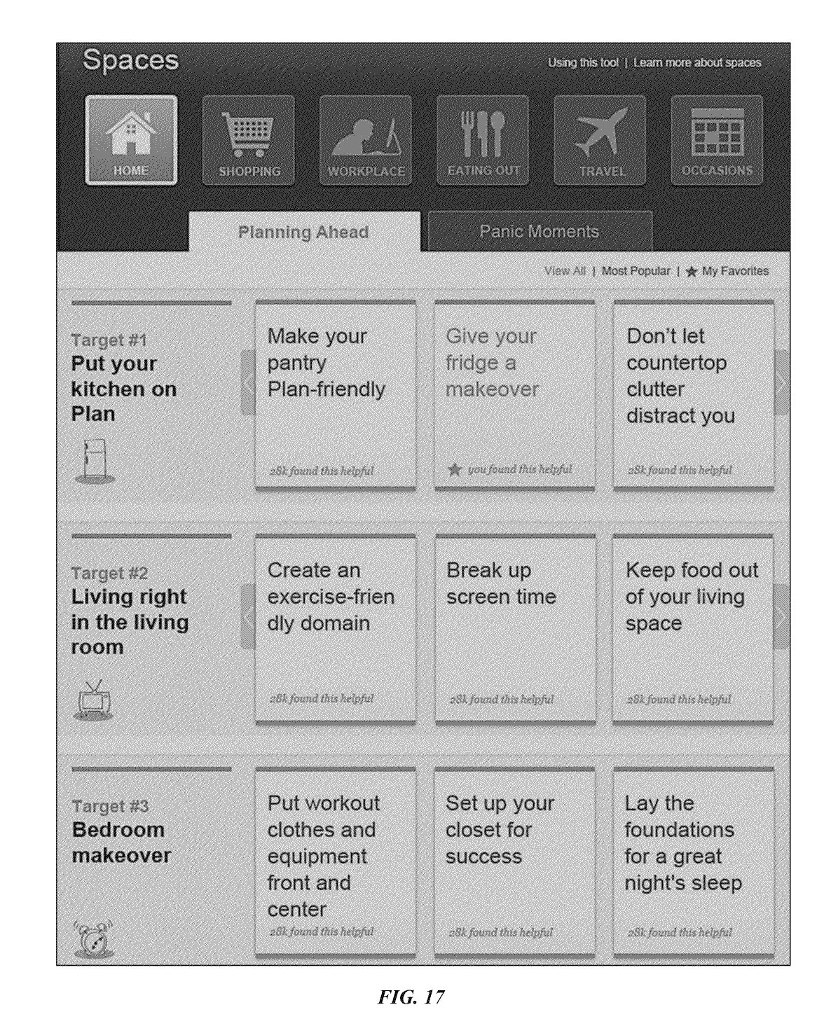

In some embodiments, the screenshots of FIGS. 16-24 illustrate another game in accordance with the instant invention.

In some embodiments, the games of the instant invention incorporate some or all features illustrated by the screenshots of FIGS. 3-33.

In some of embodiments, the exemplary games of the instant invention can be customized and/or personalized as, for example, at least one of the following ways:
plan customization (e.g., if the routines are included in the Product, choice options to customize/personalize your Product);
personalized variables (e.g., gender, goals, parameters, and/or frequency can vary based on a player's need(s));
tiered product personalization (e.g., certain players prefer to perform “advanced” versions of routines, instead of starting off with a basic version: for example, people who already run 5 k distances do not need to “walk 5 min a day” but maybe they want to start “running 6 k a day”);
automatically customize and/or player-customized (e.g., a player can edit the routine to suit his/her personal need(s), and/or can customize the routine automatically based on player's personal and/or historical playing information);
frequency (e.g., daily, weekly, bi-weekly, etc.); and
length (e.g., a pre-determined or undefined number of times/repeats to do routine and/or activity, for example: 3 times a day for a week, once a day forever, 2 times a week for a month, 10 times until complete, etc.).

In some of embodiments, the instant invention allows for a Tier-Product personalization (e.g., a subsequent tier can be personalized depending on how a player performed on in a first tier).

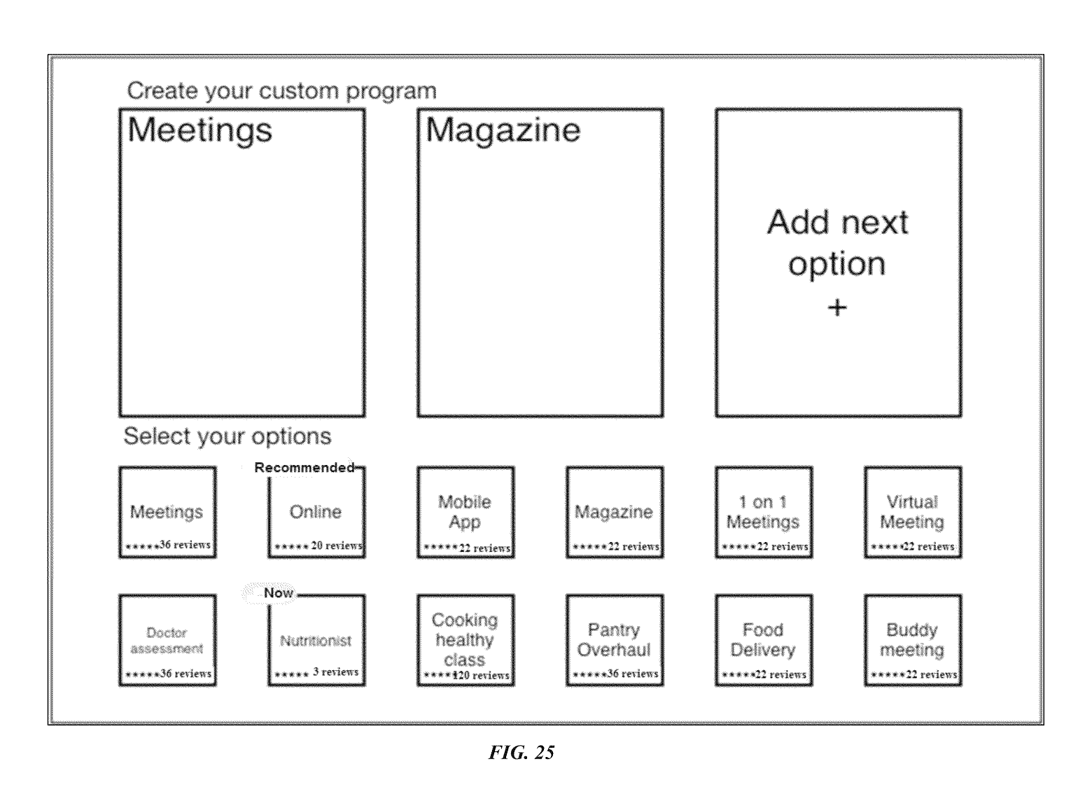

In some of embodiments, the exemplary games of the instant invention can allow at least one of the following ways for players to play:
group challenges (e.g., players perform a routine together, or compete against one another for who does it first and/or most and/or best, etc.);
community check-in (e.g., players perform a routine as part of a community so that the community can hold players accountable)
build-a-meeting/community (e.g., with friends, doctor, etc (as shown, for example, in FIG. 25);
geo-targeting (e.g., check into a weight control group meeting, check into your gym, etc.);
integration with other weight control tools/programs (e.g., tracking a certain food can automatically trigger a routine as “done” for the day);
automatic/smart tracking (e.g., if a player performs a healthy check, that information can be automatically communicated to a routine); and
utilize various communication media/tools (e.g., SMS/MMS Facebook, etc.).

In some of embodiments, the exempla games of the instant invention can allow players to track their participation by at least one of the following ways:
progress charting;
scoring, and
doctor's review.

In some of embodiments, players' participation in the exemplary games of the instant invention can or cannot be moderated and/or coached by at least one of the following ways:
a physical person (e.g., video chat, in-person, pre-corded video-mails, phone calls, etc.);
a digital avatar (e.g., avatar is programmed to be a moderator, like the Microsoft Office's “clippy”); and
a person in the Routine community (e.g., a person from a Challenge that player(s) are also participating in).

In some embodiments, the method may include, but is not limited to, receiving a reward/prize or equivalent. In some embodiments, the reward/prize or equivalent may include, but is not limited to, a monetary or non-monetary reward/prize. The reward/prize may include, but is not limited to, membership discounts, membership points for restaurants, movies or the like, gift cards, cash, prepaid debit cards, discounts on travel, discounted or free athletic equipment, discounted or free prepared food, sweepstakes entries or any other type of reward/prize.

In some embodiments, the reward/prize is received if the first data indicates completion of one or more activities and/or routines. In some embodiments, the reward/prize is received if the first data indicates completion of more than one activities and/or routines. In some embodiments, the reward/prize is received if the first data indicates completion of two activities and/or routines. In some embodiments, the reward/prize is received if the first data indicates completion of three activities and/or routines.

In some of embodiments, players' participation in the exemplary games of the instant invention can be rewarded in at least one of the following ways:
monetary;
discounts & extensions;
free pass (e.g., free movie pass);
discounts with affiliated businesses;
badges & achievements;
social recognition;
pubic recognition;
digital serotonin (e.g., an avatar that (1) gets excited and happy when a player completes a routine many times in a row and (2) turns sad when the player does not check-in for a period of time);
reward program (“redeemable reward points”);
rewards in physical form;
printed via a 3D printer; and
Good behavior.

In some of embodiments, players can participate in the exemplary games of the instant invention by at least one of the following ways (social/community/crowd integration):
sharing routines;
rating routines;
reviewing routines;
leaving tips for others;
prescribed routines (e.g., routines originated from a medical expert),
create, edit, and/or customize routines;
cheering on others who are doing routines;
tiering authorship and designation (e.g., fitness expert vs. leader); and
making suggestion(s) and/or recommending routine(s).

In some of embodiments, the exemplary games of the instant invention incorporate at least one of the following features:
routine participation leaderboard(s);
routine creation leaderboard(s);
bonus round(s);
power-up(s)/level-up(s) (e.g., recommendations, upsell to paid products, providing more impactful routines, etc.: the more you do, the more is “unlocked” for you to play; establishing levels between routines to achieve a final mastery);
“cheat” codes (e.g., an excuse for missing a day out of a 30 day routine); and
earned “tool(s)” for routines with participation (e.g., (1) “unlock” a cheat day if a player does a routine 20 times; (2) “unlock” the ability to create routines after a player has mastered at least 3 routines).

In some embodiments, the instant invention may include a method of conducting a game that includes the steps of: providing at least one first game piece, where the at least one first game piece has a first game data of the game, where the first game data includes a plurality of activities and/or routines, selecting one or more of the activities and/or routines; providing, by a computer system, first data related to the one or more of the activities and/or routines, wherein the first data includes information related to whether a user has completed the one or more activities and/or routines; receiving, by a computer system, second data based at least in part on the first data; wherein the second data is capable of enabling a user to monitor information related to the selected one or more of the activities and/or routines.

In some embodiments, the game includes selecting one or more routines and/or activities from a plurality of choices of routines and/or activities. In some embodiments, the game also includes providing information/data related to the selected routine and/or activity. In some embodiments, the information/data includes, but is not limited to, a response to an inquiry whether the user completed the selected activity and/or routine.

In some embodiments, the game further includes receiving information/data related to the routine and/or activity based at least in part on the information/data provided. In some embodiments, this information/data may include, but is not limited to, a summary of the history related to the routine such as the number of times the user completed the routine. In some embodiments, this information/data may include, but is not limited to, a positive statement such as “You rule”, “Excellent”, “You're crushing it” and/or any other statement related to the routine and/or activity. In some embodiments, the positive statement is received if the first data indicates completion of at least one routine and/or activity. In some embodiments, the positive statement is received if the first data indicates completion of more than one routine and/or activity.

Of note, the embodiments described herein may, of course, be implemented using any appropriate computer system hardware and/or computer system software. In this regard, those of ordinary skill in the art are well versed in the type of computer hardware that may be used (e.g., a mainframe, a mini-computer, a personal computer (“PC”), a network (e.g., an intranet and/or the internet)), the type of computer programming techniques that may be used (e.g., object oriented programming), and the type of computer programming languages that may be used (e.g., C++, Basic, AJAX, Javascript). The aforementioned examples are, of course, illustrative and not restrictive.

In some embodiments, the instant invention provides for a computer-implemented interactive lifestyle reinforcement game that includes at least the following steps of: (1) displaying, by a specifically programmed computer system, to a player, a first visual area and a second visual area of the game; where the first visual area includes a first plurality of X panes, where each X pane includes: i) at least one first description of at least one first routine that the player can select to perform, or ii) at least one second description of at least one first activity that the player can select to perform; where the second visual area includes Y subareas, and where a first number of Y subareas is less than a second number of the first plurality of X panes; (2) moving, by the specifically programmed computer system, each X pane selected by the player into one of the Y subareas of the second visual area until all Y subareas are filled with the player's selected X panes; (3) periodically and automatically requesting, by the specifically programmed computer system, from the player, to confirm that the player has performed each selected routine, each selected activity, or both; where a frequency of requesting depends, at least in part, on: i) at least one first performance condition associated with such selected routine, ii) at least one second performance condition associated with such selected activity, or iii) both; (4) displaying, by the specifically programmed computer system, at least one first indication that identifies player's progress in performing: i) such selected routine, ii) such selected activity, or iii) both; (5) generating, by the specifically programmed computer system, to the player, at least one first feedback based on the player's progress in performing: i) such selected routine, ii) such selected activity, or iii) both; (6) automatically removing, by the specifically programmed computer system, a completed routine or a completed activity from an associated Y subarea; where the completed routine is such selected routine which the player has performed a pre-determined number of times in accordance with the at least one first performance condition associated with such selected routine; where the completed activity is such selected activity which the player has performed in accordance with the at least one second performance condition associated with such selected activity; (7) allowing, by the specifically programmed computer system, the player to select a new routine, a new activity, or both, from the pool of available X panes; (8) moving, by the specifically programmed computer system, the new routine or the new activity into each Y subarea which has been freed when the specifically programmed computer system removed the completed routine or the completed activity; and (9) repeating, by the specifically programmed computer system, steps (1) through (8) based on the player's desire or until there are no more available X panes.

In some embodiments, the at least one first routine, the at least one first activity, or both, are configured to result in controlling a physical weight of the player. In some embodiments, the first visual area and the second visual area of the game are displayed on a screen of a mobile electronic device of the player.

In some embodiments, the game can further includes: awarding, by the specifically programmed computer system, at least one reward to the player based at least in part on one of the following: i) the at least one first performance condition associated with such selected routine, ii) the at least one second performance condition associated with such selected activity, iii) the player's progress in performing: a) such selected routine, b) such selected activity, or c) both; iv) the completed routine, v) the completed activity, vi) first historical game data associated with the player and such selected routine, and vii) second historical game data associated with the player and such selected activity.

In some embodiments, the at least one reward includes at least one of the following: a first membership discount for a first membership with at least one first business which is associated with the game, a second membership discount for a second membership with at least one second business which is not associated with the game, at least one first membership reward unit associated with the first membership with the at least one first business, at least one second membership reward unit associated with the second membership with the at least one second business, at least one gill card, a monetary cash amount, at least one prepaid debit card, at least one travel discount, at least one discounted athletic equipment, at least one free athletic equipment, at least one discounted prepared food, at least one free prepared food, at least one sweepstakes entry, at least one visual badge, and at least one public recognition identification.

In some embodiments, the at least one first membership reward unit, the at least one second membership reward unit, or both, are quantified in traveled miles or loyalty points. In some embodiments, the at least one first feedback is at least one positive reinforcement signal. In some embodiments, the at least one positive reinforcement signal is at least one of the following: i) at least one written positive statement, ii) at least one verbal positive statement, and iii) at least one visual signal.

In some embodiments, the first number is three. In some embodiments, the first number is between three and seven.

In some embodiments, the instant invention provides for a specially programmed computer system that includes at least the following components: at least one specialized computer machine that includes: a non-transient memory having at least one region for storing particular computer executable program code; and at least one processor for executing the particular program code stored in the memory, where the particular program code is configured so that the at least one specialize computer machine is configured to at least perform the following operations for conducting interactive lifestyle reinforcement game: (1) displaying, by a specifically programmed computer system, to a player, a first visual area and a second visual area of the game; where the first visual area includes a first plurality of X panes, where each X pane includes: i) at least one first description of at least one first routine that the player can select to perform, or ii) at least one second description of at least one first activity that the player can select to perform; where the second visual area includes Y subareas, and where a first number of Y subareas is less than a second number of the first plurality of X panes; (2) moving, by the specifically programmed computer system, each X pane selected by the player into one of the Y subareas of the second visual area until all Y subareas are filled with the player's selected X panes; (3) periodically and automatically requesting, by the specifically programmed computer system, from the player, to confirm that the player has performed each selected routine, each selected activity, or both; where a frequency of requesting depends, at least in part, on: i) at least one first performance condition associated with such selected routine, ii) at least one second performance condition associated with such selected activity, or iii) both; (4) displaying, by the specifically programmed computer system, at least one first indication that identifies player's progress in performing: such selected routine, ii) such selected activity, or iii) both; (5) generating, by the specifically programmed computer system, to the player, at least one first feedback based on the player's progress in performing: i) such selected routine, ii) such selected activity, or both; (6) automatically removing, by the specifically programmed computer system, a completed routine or a completed activity from an associated Y subarea; where the completed routine is such selected routine which the player has performed a pre-determined number of times in accordance with the at least one first performance condition associated with such selected routine; where the completed activity is such selected activity which the player has performed in accordance with the at least one second performance condition associated with such selected activity; (7) allowing, by the specifically programmed computer system, the player to select a new routine, a new activity, or both, from the pool of available X panes; (8) moving, by the specifically programmed computer system, the new routine or the new activity into each Y subarea which has been freed when the specifically programmed computer system removed the completed routine or the completed activity; and (9) repeating, by the specifically programmed computer system, the operations (1) through (8) based on the player's desire or until there are no more available X panes.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

What is claimed is:

1. A computer-implemented interactive lifestyle reinforcement game, comprising:
(1) displaying, by a specifically programmed computer system, to a player, a first visual area and a second visual area of the game;
wherein the first visual area comprises a first plurality of X panes, where each X pane comprises:
i) at least one first description of at least one first routine that the player can select to perform, or
ii) least one second description of at least one first activity that the player can select to perform;
wherein the second visual area comprises Y subareas, and where a first number of Y subareas s less than a second number of the first plurality of X panes;
(2) moving, by the specifically programmed computer system, each X pane selected by the player into one of the Y subareas of the second visual area until all Y subareas are filled with the player's selected X panes;
(3) periodically and automatically requesting, by the specifically programmed computer system, from the player, to confirm that the player has performed each selected routine, each selected activity, both; wherein a frequency of requesting depends, at least in part, on:
i) at least one first performance condition associated with such selected routine,
ii) at least one second performance condition associated with such selected activity, or
iii) both;
(4) displaying, by the specifically programmed computer system, at least one first indication that identifies player's progress in performing:
i) such selected routine,
ii) such selected activity, or
iii) both;
(5) generating, by the specifically programmed computer system, to the player, at least one first feedback based on the player's progress in performing:
i) such selected routine,
ii) such selected activity, or
iii) both;
(6) automatically removing, by the specifically programmed computer system, a completed routine or a completed activity from an associated Y subarea;
wherein the completed routine is such selected routine which the player has performed a pre-determined number of times in accordance with the at least one first performance condition associated with such selected routine;
wherein the completed activity is such selected activity which the player has performed in accordance with the at least one second performance condition associated with such selected activity;
(7) allowing, by the specifically programmed computer system, the player to select a new routine, a new activity, or both, from the pool of available X panes;
(8) moving, by the specifically programmed computer system, the new routine or the new activity into each Y subarea which has been freed when the specifically programmed computer system removed the completed routine or the completed activity; and
(9) repeating, by the specifically programmed computer system, steps (1) through (8) based on the player's desire or until there are no more available X panes.

2. The computer-implemented interactive lifestyle reinforcement game of claim 1, wherein the at least one first routine, the at least one first activity, or both, are configured to result in controlling a physical weight of the player.

3. The computer-implemented interactive lifestyle reinforcement game of claim 1, wherein the first visual area and the second visual area of the game are displayed on a screen of a mobile electronic device of the player.

4. The computer-implemented interactive lifestyle reinforcement game of claim 1, wherein the game further comprises:
awarding, by the specifically programmed computer system, at east one reward to the player based at least in part on one of the following:
i) the at least one first performance condition associated with such selected routine,
ii) the at least one second performance condition associated with such selected activity,
iii) the player's progress in performing:
a) such selected routine,
b) such selected activity, or
c) both;
iv) the completed routine,
v) the completed activity,
vi) first historical game data associated with the player and such selected routine, and
vii) second historical game data associated with the player and such selected activity.

5. The computer-implemented interactive lifestyle reinforcement game of claim 4, wherein the at least one reward comprises at least one of the following:
i) a first membership discount for a first membership with at least one first business which is associated with the game,
ii) a second membership discount for a second membership with at least one second business which is not associated with the game,
iii) at least one first membership reward unit associated with the first membership with the at least one first business,
iv) at least one second membership reward unit associated with the second membership with the at least one second business,
v) at least one gift card,
vi) a monetary cash amount,
vii) at least one prepaid debit card,
viii) at least one travel discount,
ix) at least one discounted athletic equipment,
x) at least one free athletic equipment,
xi) at least one discounted prepared food,
xii) at least one free prepared food,
xiii) at least one sweepstakes entry,
xiv) at least one visual badge, and
xv) at least one public recognition identification.

6. The computer-implemented interactive lifestyle reinforcement game of claim 5, wherein the at least one first membership reward unit, the at least one second membership reward unit, or both, are quantified in traveled miles or loyalty points.

7. The computer-implemented interactive lifestyle reinforcement game of claim 1, wherein the at least one first feedback is at least one positive reinforcement signal.

8. The computer-implemented interactive lifestyle reinforcement game of claim 7, wherein the at least one positive reinforcement signal is at least one of the following:
i) at least one written positive statement,
ii) at least one verbal positive statement, and
iii) at least one visual signal.

9. The computer-implemented interactive lifestyle reinforcement game of claim 1, wherein the first number is three.

10. The computer-implemented interactive lifestyle reinforcement game of claim 1, wherein the first number is between three and seven.

11. A computer-implemented system for conducting, comprising:
at least one specialized computer machine, comprising:
a non-transient memory having at least one region for storing particular computer executable program code; and
at least one processor for executing the particular program code stored in the memory, wherein the particular program code is configured so that the at least one specialize computer machine is configured to at least perform the following operations for conducting interactive lifestyle reinforcement game:
(1) displaying, to a player, a first visual area and a second visual area of the game;
wherein the first visual area comprises a first plurality of X panes, where each X pane comprises:
i) at least one first description of at least one first routine that the player can select to perform, or
ii) at least one second description of at least one first activity that the player can select to perform;
wherein the second visual area comprises Y subareas, and where a first number of Y subareas is less than a second number of the first plurality of X panes;
(2) moving each X pane selected by the player into one of the Y subareas of the second visual area until all Y subareas are filled with the player's selected X panes;
(3) periodically and automatically requesting, from the player, to confirm that the player has performed each selected routine, each selected activity, or both; wherein a frequency of requesting depends, at least in part, on:
i) at least one first performance condition associated with such selected routine,
ii) at least one second performance condition associated with such selected activity, or
iii) both;
(4) displaying at east one first indication that identifies player's progress in performing:
i) such selected routine,
ii) such selected activity, or
iii) both;
(5) generating, to the player, at least one first feedback based on the player's progress in performing:
i) such selected routine,
ii) such selected activity, or
iii) both;
(6) automatically removing a completed routine or a completed activity from an associated Y subarea;
wherein the completed routine is such selected routine which the player has performed a pre-determined number of times in accordance with the at least one first performance condition associated with such selected routine;
wherein the completed activity is such selected activity which the player has performed in accordance with the at least one second performance condition associated with such selected activity;
(7) allowing the player to select a new routine, a new activity, or both, from the pool of available X panes;
(8) moving the new routine or the new activity into each Y subarea which has been freed when the specifically programmed computer system removed the completed routine or the completed activity; and
(9) repeating the operations (1) through (8) based on the player's desire or until there are no more available X panes.

12. The system of claim 11, wherein the at least one first routine, the at least one first activity, or both, are configured to result in controlling a physical weight of the player.

13. The system of claim 11, wherein the first visual area and the second visual area of the game are displayed on a screen of a mobile electronic device of the player.

14. The system of claim 11, wherein the operations for conducting interactive lifestyle reinforcement game further comprise:
awarding at least one reward to the player based at least in part on one of the following:
i) the at least one first performance condition associated with such selected routine,
ii) the at least one second performance condition associated with such selected activity,
iii) the player's progress in performing:
a) such selected routine,
b) such selected activity, or
c) both;
iv) the completed routine,
v) the completed activity,
vi) first historical game data associated with the player and such selected routine, and
vii) second historical game data associated with the player and such selected activity.

15. The system of claim 14, wherein the at least one reward comprises at least one of the following:
i) a first membership discount for a first membership with at least one first business which is associated with the game,
ii) a second membership discount for a second membership with at least one second business which is not associated with the game,
iii) at least one first membership reward unit associated with the first membership with the at least one first business,
iv) at least one second membership reward unit associated with the second membership with the at least one second business,
v) at least one gift card,
vi) a monetary cash amount,
vii) at least one prepaid debit card,
viii) at least one travel discount,
ix) at least one discounted athletic equipment,
x) at least one free athletic equipment,
xi) at least one discounted prepared food,
xii) at least one free prepared food,
xiii) at least one sweepstakes entry,
xiv) at least one visual badge, and
xv) at least one public recognition identification.

16. The system of claim 15, wherein the at least one first membership reward unit, the at least one second membership reward unit, or both, are quantified in traveled miles or loyalty points.

17. The system of claim 11, wherein the at least one first feedback is at least one positive reinforcement signal.

18. The system of claim 17, wherein the at least one positive reinforcement signal is at least one of the following:
i) at least one written positive statement,
ii) at least one verbal positive statement, and
iii) at least one visual signal.

19. The system of claim 11, wherein the first number is three.

20. The system of claim 11, wherein the first number is between three and seven.
